(19) United States
(12) Patent Application Publication
(10) Pub. No.: US 2024/0256691 A1
(43) Pub. Date: Aug. 1, 2024

(54) SYSTEM AND METHOD FOR MINTING NON-FUNGIBLE TOKEN

(71) Applicant: Mod haus Inc., Seoul (KR)

(72) Inventor: Junyoup HWANG, Seoul (KR)

(21) Appl. No.: 18/361,214

(22) Filed: Jul. 28, 2023

(30) Foreign Application Priority Data
Jan. 17, 2023 (KR) 10-2023-0007019

(51) Int. Cl. G06F 21/62; G06F 16/22; G06Q 20/36; G06Q 20/38

(52) U.S. Cl. CPC G06F 21/6218; G06F 16/2255; G06Q 20/3672; G06Q 20/389; G06K 7/1413

(57) ABSTRACT

The present technology relates to a method and system for managing a non-fungible token. A non-fungible token minting method according to the present technology, which is a non-fungible token (NFT) minting method of minting an NFT to a blockchain network, includes: generating non-fungible token information, including digital content information, a token identification number, and a token ID; storing the non-fungible token information at an address corresponding to token identification information; receiving user identification information through a user terminal to create a blockchain wallet corresponding to the user identification information; matching and storing wallet address information of the blockchain wallet with the user identification information; and receiving the token identification information through the user terminal and minting the non-fungible token to the blockchain wallet having the wallet address information matched with the user identification information using the non-fungible token information stored at the address corresponding to the token identification information.

### CROSS-REFERENCE TO RELATED APPLICATION

The present application claims priority under 35 U.S.C. § 119(a) to Korean patent application no. 10-2023-0007019 filed on Jan. 17, 2023, in the Korean Intellectual Property Office, the entire disclosure of which is incorporated by reference herein.

### TECHNICAL FIELD

The present disclosure relates to a method and system for minting a non-fungible token (NFT). More specifically, the present disclosure relates to a method and system for minting a non-fungible token allowing a user to mint a non-fungible token simply by receiving unique token identification information or Uniform Resource Locator (URL) information of the non-fungible token by a user terminal without going through a complicated process.

### RELATED ART

Blockchain refers to data management technology that records continuously increasing data in a block of a specific unit and manages a plurality of blocks in a chain-like data structure by each of nodes forming a peer-to-peer (P2P) network, or data itself having the chain-like data structure. Here, the blockchain having the chain-like data structure operates in the form of a distributed ledger at each node without intervention of a central system.

A blockchain-based system performs a consensus process across a network to ensure integrity and conformity of data in a distributed environment. The consensus process is carried out through processes such as block generation, block propagation, and block verification, and blockchain-based systems proposed so far perform the consensus process using consensus algorithms such as proof of work and proof of stake.

Blockchains are divided into permissionless blockchains and permissioned blockchains. A permissionless blockchain is a blockchain that allows users and nodes to participate in a blockchain network without any restrictions. Typical permissionless blockchains include Bitcoin and Ethereum. A permissioned blockchain is a blockchain suitable for use in a business environment that allows only authorized users and nodes to participate in the blockchain network. Typical permissioned blockchains include Hyperledger Fabric.

Smart contracts refer to various types of contracts such as notarization and real estate contracts that are concluded and executed based on the blockchain. Through the smart contracts, business logic may be configured to develop and operate distributed applications (dApps). The smart contracts have an advantage of automatically executing requests according to business logic without intervention of a third party. A typical dApp is a token.

A token is a representation of a digital asset on the blockchain. Tokenizing digital assets on the blockchain may provide benefits such as proof of ownership of digital assets, transparency, and liquidity guarantees. Tokens are divided into fungible tokens and non-fungible tokens. A fungible token is a token that represents a digital asset that can be divided.

On the other hand, a non-fungible token is a token that represents a digital asset that cannot be divided, and uses blockchain technology to prove the owner of the digital asset. The non-fungible token is used to indicate its inherent originality and ownership by embedding an address that points to a digital file such as a picture or video in the token. The non-fungible tokens are unique and similar to national ID cards that cannot be identical. The non-fungible tokens are guaranteed to be unique by permanently leaving trade details on the blockchain. Currently, the non-fungible tokens are used for various purposes such as (1) collectibles such as art and cards, (2) Profile Picture (PFP) for use as a profile picture on Social Network Service (SNS), (3) a ticket (Pass) to participate in any project, community, or performance, (4) physital (physical+digital) provided in connection with actual goods, (5) certificates proving rights such as copyright, ownership, and intellectual property rights, and (6) items, characters, and land in a game, and use of the non-fungible tokens is increasing.

In order to acquire a non-fungible token, it is required to participate in the minting of the non-fungible token, or purchase the non-fungible token that has already been minted through trade to receive the non-fungible token transferred from the owner. In general, in order to acquire the non-fungible token in Korea, the following process is required.
(1) A user signs up for a domestic digital asset exchange such as Upbit or Bithumb, opens a bank account in his or her name to register it on the exchange, and, after customer verification is completed, deposits the cost for purchasing a digital asset, i.e., a coin or token, in Korean won to the exchange through the bank account. After that, the user purchases the coin or token listed on the exchange using the won currency.
(2) The user should create (or configure) a personal blockchain wallet such as Meta Mask and transfer the coin or token purchased on the exchange to be displayed in the personal blockchain wallet. When the personal blockchain wallet is created (or configured), a public key and a private key are generated, and the user who creates (or configures) the personal blockchain wallet may check the exact amount of the coin or token the user owns through interaction between the personal blockchain wallet and the blockchain. For reference, a blockchain wallet may be referred to as a bridge that connects a user with coins or tokens that exist on the blockchain. The user who uses the blockchain wallet can buy, sell, store, and use coins or tokens through the blockchain wallet.
(3) The user should visit a website that mints non-fungible tokens or a website that supports trade of non-fungible tokens [e.g., OpenSea(https://opensea.io)] and connect the website with the personal blockchain wallet. When the website minting non-fungible tokens is connected to the personal blockchain wallet, the user may own a non-fungible token by minting the non-fungible token or executing transactions to trade the non-fungible token. A transaction refers to the ‘smallest unit of business processing that cannot be divided’ and represents details of each trade made in the blockchain. In order to execute a transaction, a coin used in the blockchain network (for example, Ethereum in the case of the Ethereum mainnet) should be paid as a gas fee, which can be referred to as a kind of “trade fee”.

However, for a person who is not accustomed to using a personal blockchain wallet, the process of acquiring non-fungible tokens using the personal blockchain wallet as described above is very complicated. Further, it is difficult for minors to open a bank account without the consent of their legal representative, and since they cannot sign up for domestic exchanges, it is practically impossible for minors to own non-fungible tokens. In addition, when the user transfers tokens or coins, in the case that the user chooses a wrong blockchain network to send them to or sends coins or tokens to a wrong address, the user can never get them back, and when the user incorrectly connects his or her personal blockchain wallet to a phishing site, the user risks being hacked. Due to these problems, even though it has been about 15 years since Bitcoin was first introduced to the world in 2008, there has been still a problem in that all but a very small number of people are unable to mint and trade non-fungible tokens. In addition, as the use of non-fungible tokens increases, many people want to mint and trade non-fungible tokens, but there has been a problem in that they cannot participate in minting and trading non-fungible tokens due to the complexity of the trade process and the risk of property loss.

### PRIOR ART DOCUMENT

### Patent Document

(Patent Document 0001) Korean Patent Application Publication No. 10-2022-0135521 (published on Oct. 7, 2022)

### CONTENT OF THE INVENTION

### Problem to be Solved

A technical object to be achieved by the present disclosure is to provide a method and system for minting a non-fungible token that allow a user to easily mint and store a non-fungible token even if the user does not sign up for a domestic digital asset exchange or create his or her personal blockchain wallet.

Another technical object to be achieved by the present disclosure is to provide a method and system for minting a non-fungible token that allows the user to easily mint and store a non-fungible token using information displayed on a tangible object.

Technical objects of the present disclosure are not limited to the above-mentioned technical objects, and other technical objects not mentioned can be clearly understood by those skilled in the art to which the present disclosure pertains from the following description.

### Means of Solving the Problem

In accordance with an aspect of the present disclosure, there is provided a non-fungible token minting method a which is a non-fungible token (NFT) minting method of minting an NFT to a blockchain network, including: generating non-fungible token information, including digital content information, a token identification number, and a token ID; storing the non-fungible token information at an address corresponding to token identification information; receiving user identification information through a user terminal to create a blockchain wallet corresponding to the user identification information; matching and storing wallet address information of the blockchain wallet with the user identification information; and receiving the token identification information through the user terminal and minting the non-fungible token to the blockchain wallet having the wallet address information matched with the user identification information using the non-fungible token information stored at the address corresponding to the token identification information.

The NFT minting method may further include visualizing the token identification information to display it on a tangible object.

The visualizing of the token identification information to display it on the tangible object may include converting the token identification information into a barcode or QR code to display it on the tangible object.

The minting of the non-fungible token may include allowing a token used as a fee required to execute a transaction to mint the non-fungible token to be transferred from a blockchain wallet other than the blockchain wallet to which the non-fungible token is minted.

The minting of the non-fungible token may include transferring a token used as a fee required to execute a transaction to mint the non-fungible token to the blockchain wallet to which the non-fungible token is minted prior to executing the transaction to mint the non-fungible token.

The NFT minting method may further include checking an amount of tokens used as a fee required to execute a transaction to mint the non-fungible token held in the blockchain wallet and, when the amount of the tokens is lower than a predetermined value, transferring the token used as the fee to the blockchain wallet.

The NFT minting method may further include matching and storing approval information for approving a transaction to mint the non-fungible token to the blockchain wallet with the user identification information.

The minting of the non-fungible token may include receiving the token identification information through the user terminal as input; when the token identification information is input through the user terminal, retrieving the non-fungible token information from the address corresponding to the token identification information; requesting the token ID included in the non-fungible token information and the wallet address information matched with the user identification information to be transferred to a contract address of the non-fungible token; and retrieving the approval information matched with the user identification information to approve the request.

The digital content information may include one or more of image data, sound source data, and video data.

The user identification information may include one or more of an e-mail address of the user and a unique name of the user input by the user.

In accordance with another aspect of the present disclosure, there is provided a non-fungible token minting method which is a non-fungible token (NFT) minting method of minting an NFT to a blockchain network using an application, including: generating non-fungible token information including digital content information, a token serial number, Uniform Resource Locator (URL) information, and a token ID, and storing the non-fungible token information at an address indicated by the URL information; visualizing the URL information to display it on a tangible physical card; registering user identification information for identifying a user through a user terminal, and creating a blockchain wallet corresponding to the user identification information; when the blockchain wallet is created, matching and storing wallet address information of the blockchain wallet with the user identification information; and minting the non-fungible token to the blockchain wallet by recognizing the URL information displayed on the physical card through the user terminal while the application is active and recording the token ID and the wallet address information stored at the address indicated by the URL information to the blockchain network through the application.

The visualizing of the URL information to display it on a tangible object may include converting the URL information into a barcode or a QR code to display it on the physical card.

The minting of the non-fungible token may include allowing a token used as a fee required to execute a transaction to mint the non-fungible token to be transferred from a blockchain wallet other than the blockchain wallet to which the non-fungible token is minted.

The minting of the non-fungible token may include transferring a token used as a fee required to execute a transaction to mint the non-fungible token to the blockchain wallet to which the non-fungible token is minted prior to executing the transaction to mint the non-fungible token.

The NFT minting method may further include checking an amount of tokens used as a fee required to execute a transaction to mint the non-fungible token held in the blockchain wallet and, when the amount of the tokens is lower than a predetermined value, transferring the token used as the fee to the blockchain wallet.

The NFT minting method may further include matching and storing approval information for approving a transaction to mint the non-fungible token to the blockchain wallet with the user identification information.

The minting of the non-fungible token may including recognizing the URL information displayed on the physical card through the user terminal while the application is active; when the URL information is recognized through the user terminal, retrieving the non-fungible token information from the address indicated by the URL information; requesting the token ID included in the retrieved non-fungible token information and the wallet address information matched with the user identification information to be transferred to a contract address of the non-fungible token; and retrieving the approval information matched with the user identification information to approve the request.

The digital content information may include one or more of image data, sound source data, and video data.

The URL information may include the token serial number.

The user identification information may include one or more of an e-mail address of the user and a unique name of the user input by the user.

In accordance with another aspect of the present disclosure, there is provided a non-fungible token minting system which is a non-fungible token (NFT) minting system for minting an NFT to a blockchain network at a request of a user terminal, including: a content information storage configured to store digital content information including one or more of image data, sound source data, and video data; a token information storage configured to store one or more non-fungible token information including corresponding digital content information, a token identification number, and a token ID, at an address corresponding to the token identification information; and a control server configured to, when user identification information is input through the user terminal, create a blockchain wallet corresponding to the user identification information, and match and store wallet address information of the blockchain wallet with the user identification information, and when the token identification information is input through the user terminal, mint the non-fungible token to the blockchain wallet having the wallet address information matched with the user identification information using the non-fungible token information stored at the address corresponding to the token identification information.

The token identification information may be visualized and displayed on a tangible object.

The token identification information may be converted into a barcode or QR code and displayed on a tangible object.

The control server may be configured to allow a token used as a fee required to execute a transaction to mint the non-fungible token to be transferred from a blockchain wallet other than the blockchain wallet to which the non-fungible token is minted.

The control server may be configured to transfer a token used as a fee required to execute a transaction to mint the non-fungible token to the blockchain wallet to which the non-fungible token is minted prior to executing the transaction to mint the non-fungible token.

The control server may be configured to check an amount of tokens used as a fee required to execute a transaction to mint the non-fungible token held in the blockchain wallet and, when the amount of the tokens is lower than a predetermined value, transfer the token used as the fee to the blockchain wallet.

The non-fungible token minting system may further include a wallet information storage configured to store the wallet address information matched with the user identification information and approval information for approving a transaction of the blockchain wallet.

The control server may be configured to control the wallet address information matched with the user identification information and the approval information to be stored in the wallet information storage; and in the case that the token identification information is input through the user terminal when the non-fungible token is minted, retrieve the non-fungible token information from an address indicated by the token identification information, request the token ID and the wallet address information matched with the user identification information to be transferred to a contract address of the non-fungible token, and retrieve the approval information to approve the request.

According to embodiments of the present disclosure, a user who has not signed up for a domestic digital asset exchange or created a personal blockchain wallet by himself or herself may easily mint, store, and transfer non-fungible tokens.

In addition, according to embodiments of the present disclosure, the user may easily mint, store, and transfer non-fungible tokens using information displayed on a tangible object.

Effects according to the embodiments of the present disclosure are not limited by the above, and more various effects may be included in the present specification.

### Effects of the Invention

According to embodiments of the present disclosure, a user who has not signed up for a domestic digital asset exchange or created a personal blockchain wallet by himself or herself may easily mint, store, and transfer non-fungible tokens.

In addition, according to embodiments of the present disclosure, the user may easily mint, store, and transfer non-fungible tokens using information displayed on a tangible object.

Effects according to the embodiments of the present disclosure are not limited by the above, and more various effects may be included in the present specification.

### BRIEF DESCRIPTION OF THE DRAWINGS

FIGS. 1A to 1E are diagrams for illustrating operations of a non-fungible token minting system 10 according to an embodiment of the present disclosure.

FIG. 2 is a block diagram illustrating an overall configuration of the non-fungible token minting system 10 according to an embodiment of the present disclosure.

FIGS. 3A to 3E are diagrams for illustrating operations of the non-fungible token minting system 10 according to an embodiment of the present disclosure.

FIGS. 4A to 4C are flowcharts for illustrating a non-fungible token minting method according to an embodiment of the present disclosure.

FIGS. 5A to 5E are diagrams for illustrating operations of the non-fungible token minting system 10 according to another embodiment of the present disclosure.

FIGS. 6A to 6C are flowcharts for illustrating a non-fungible token minting method according to another embodiment of the present disclosure.

FIGS. 7A and 7B are diagrams illustrating the front (FIG. 7A) and the back (FIG. 7B) of a tangible object (physical card) used in a non-fungible token minting method and a non-fungible token minting system according to an embodiment of the present disclosure.

### DETAILED DESCRIPTION

The present disclosure may be variously modified and may have various embodiments, and specific embodiments are illustrated in the drawings and described in detail in the detailed description. However, it is not intended to limit the present disclosure to a specific embodiment, but should be understood to include all modifications, equivalents, or substitutes included in the scope of the spirit and technology of the present disclosure. In describing each drawing, like reference numerals are used for like components.

Terms such as first, second, A, and B may be used to describe various components, but the components should not be limited by the terms. The terms are used only for the purpose of distinguishing one component from another. For example, without departing the scope of the present disclosure, a first component may be referred to as a second component, and similarly, the second component may also be referred to as the first component. The term “and/or” includes a combination of a plurality of related described items or any of the plurality of related described items.

When a component is referred to as “coupled” or “connected” to another component, it should be understood that the component may be directly coupled or connected to the other component, but there may be other components therebetween. On the other hand, when a component is referred to as “directly coupled” or “directly connected” to another component, it should be understood that no other component exists therebetween.

The terms used in this application are used merely to describe particular embodiments and are not intended to limit the present disclosure. Singular expressions include plural expressions, unless the context clearly means otherwise. It should be understood that the terms “include” or “have” when used in this specification, are intended to specify the presence of stated features, integers, steps, operations, elements, components or a combination thereof, but do not preclude the presence or addition of one or more other features, integers, steps, operations, elements, components, and/or combinations thereof.

The advantages and features of the present disclosure, and the means of achieving them, will be clarified by reference to the embodiments described in detail with the accompanying drawings. However, the present invention is not limited to the embodiments disclosed below, but may be implemented in various different forms, but only the present embodiments are provided to ensure that the disclosure of the present invention is complete, and to completely inform those skilled in the art to which the present disclosure pertains, and the present invention is only defined by the appended claims.

Unless otherwise defined, all terms (including technical and scientific terms) used herein may be used as meanings that can be commonly understood by those skilled in the art to which the present disclosure pertains. In addition, terms defined in dictionaries generally used are not to be construed ideally or excessively unless otherwise defined herein. Terms used herein are intended to describe embodiments and are not intended to limit the present disclosure. In the specification, singular expressions are intended to include plural expressions, unless the context clearly indicates otherwise.

Prior to describing preferred embodiments of the present disclosure, key terms are as follows.

In the specification, a blockchain network refers to a network of a peer-to-peer (P2P) structure consisting of a plurality of blockchain nodes operating according to a blockchain algorithm (or protocol).

In this specification, a transaction or a blockchain transaction may refer to all actions that cause a state change (e.g. increase or decrease of balance, transfer of assets) in the block chain network, or data indicating those actions. The transaction may include a write-type transaction (e.g. transaction such as adding, modifying, or deleting state data). Of course, depending on the blockchain network, various types of transactions (e.g. execution) may exist in addition to the write type, and in this case, the transactions may include all of the various types of transactions. The transaction can be executed through a smart contract (e.g. access to the blockchain through functions and variables defined in the smart contract), but it may vary according to the blockchain network.

In this specification, a smart contract refers to a script or software code used for transaction processing in the blockchain network. More specifically, the smart contract is a code programmatically written for various conditions, states, and actions according to the conditions used for transaction processing, and includes, for example, a smart contract of Ethereum and a chain code of Hyperledger Fabric. The smart contract has the advantage of automatically executing requests according to business logic without the intervention of a third party.

In the blockchain network, the smart contracts also has an address, which is usually called a contract address. When the smart contract commands to do a task, the address that indicates its location is the contract address. Therefore, the contract address of the smart contract of the non-fungible token may be an address that indicates its location when the smart contract commands to do a task for the token.

A personal blockchain wallet is a means of managing digital assets (e.g., coins or tokens), and transactions of digital assets occur on the blockchain network, where public keys and private keys are used. Each of the public key and the private key has a function similar to password corresponding to the bank's account number and Internet banking login details, the public key is a key that is shared with others for the purpose of receiving digital assets at a user's account, and the private key performs the same function as a key to a secret vault. The private key provides access to digital assets that are always stored on the blockchain network. When a user creates (or configures, hereinafter referred to as ‘create’) a personal blockchain wallet (e.g., MetaMask), the public key and the private key are generated, and an exact amount of digital assets owned through interaction with the blockchain network is displayed. The blockchain wallet may be referred to as a bridge that connects the user with digital assets existing on the blockchain network, and the user may mint, purchase, sell, store, and use digital assets using the personal blockchain wallet. Here, wallet address information of the personal blockchain wallet may be the private key or information modified thereof, and approval information of the personal blockchain wallet (information used for an act such as a digital signature to execute a specific transaction) may be the private key or information modified thereof.

A user terminal described herein may include a mobile phone, a smart phone, a laptop computer, a terminal for digital broadcasting, personal digital assistants (PDA), a portable multimedia player (PMP), navigation, and a server device, but the present disclosure is not limited thereto, and the user terminal may be various other devices capable of user input and information display.

Each user terminal may have a communication module for accessing the blockchain network. The blockchain network may be implemented as, for example, a local area network (Local Area Network; LAN), Wide Area Network (LAN; WAN), or Value Added Network (VAN). In addition, the blockchain network may be implemented as all kinds of wireless networks, such as mobile radio communication network, satellite communication network, Bluetooth, Wireless Broadband Internet (Wibro), High Speed Downlink Packet Access (HSDPA), Wi-Fi, and Long Term Evolution (LTE). Depending on the need, the blockchain network may be a mixed wired and wireless network.

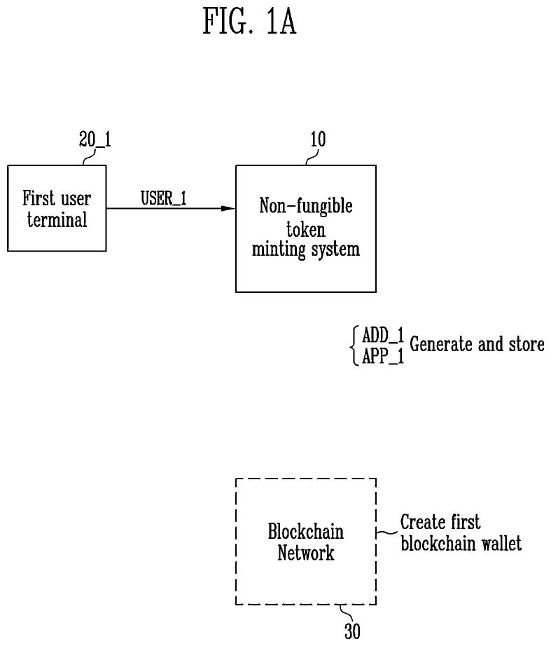

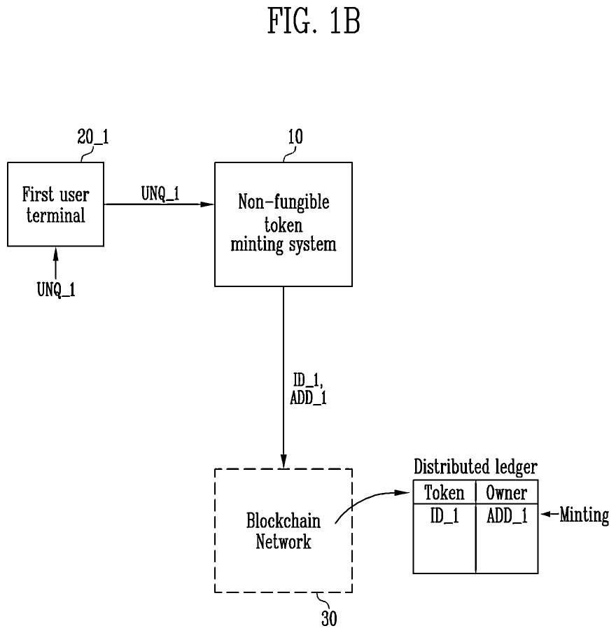

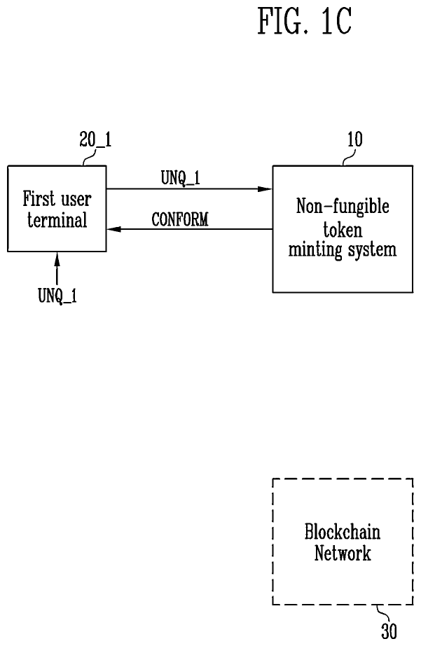

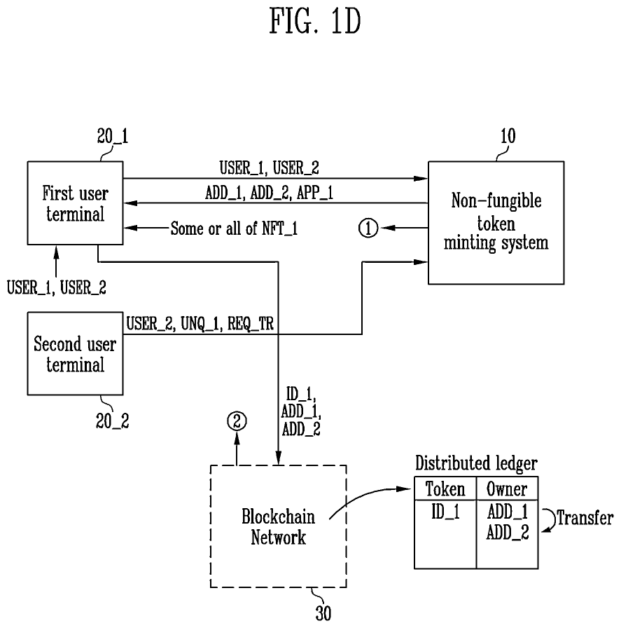

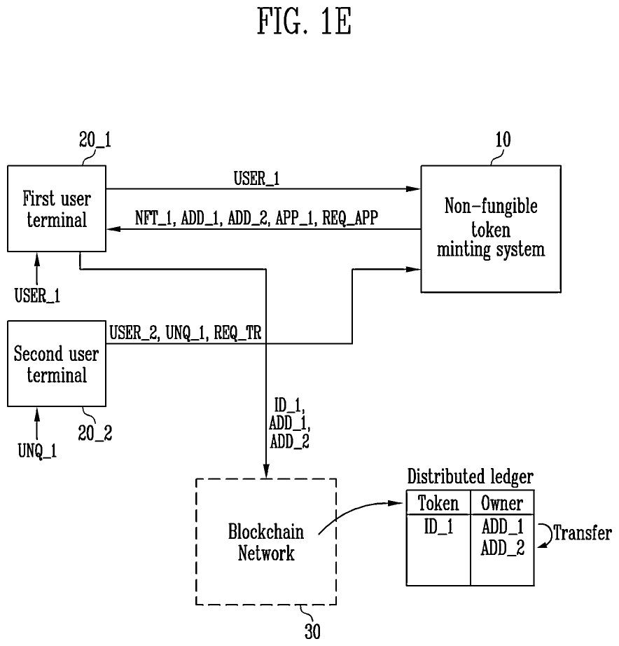

FIGS. 1A to 1E are diagrams for illustrating operations of a non-fungible token minting system 10 according to an embodiment of the present disclosure.

FIG. 1A is a diagram for illustrating a process in which a first user creates a first blockchain wallet through the non-fungible token minting system 10 according to an embodiment of the present disclosure using a first user terminal 20_1.

As shown in FIG. 1A, the first user installs an application necessary for minting, verifying, and transferring a non-fungible token using the non-fungible token minting system 10 in the first user terminal 20_1, and executes the application on the first user terminal 20_1 to register himself or herself as a user of the application. While registering himself or herself as the user of the application, the first user may register first user identification information (USER_1, e.g., an e-mail address of the first user, a first nickname input directly by the first user, etc.) that can identify the first user with other users of the application.

When the first user registers the first user identification information USER_1, the non-fungible token minting system 10 may create the first blockchain wallet used to mint, store, and transfer the non-fungible token in a blockchain network 30, and may match and store first wallet address information ADD_1 and first approval information APP_1 of the first blockchain wallet with the first user identification information USER_1. The first approval information APP_1 may be information necessary to approve a transaction in the blockchain network 30. Here, the first wallet address information ADD_1 is the public key itself or a modified version of the public key used in encrypted communication, and the first approval information APP_1 is the private key itself or a modified version used in the encrypted communication.

FIG. 1A illustrates a case in which the first user identification information USER_1, the first wallet address information ADD_1, and the first approval information APP_1 are all stored in the non-fungible token minting system 10. However, the first user identification information USER_1, the first wallet address information ADD_1, and the first approval information APP_1 may be stored inside the non-fungible token minting system 10 or may be stored in a server provided outside the non-fungible token minting system 10, and some of them may be stored inside the non-fungible token minting system 10 and the rest may be stored outside the non-fungible token minting system 10.

In addition, the first user identification information USER_1, the first wallet address information ADD_1, and the first approval information APP_1 may all be stored in one server or one or more of them may be stored in different servers. Preferably, the first wallet address information ADD_1 and the first approval information APP_1 may be encrypted and stored in an external server of the non-fungible token minting system 10. In this case, the external server (not shown) of the non-fungible token minting system 10 is managed by an administrator of the non-fungible token minting system 10 and another entity, and may be a server managed by an entity that provides Software-as-a-Service (SaaS).

If the user installs the application on the user terminal and, while registering himself or herself as a user of the application, inputs only the user identification information for discriminating himself or herself from other users, the non-fungible token minting system 10 automatically creates the blockchain wallet corresponding to the user identification information and manages the wallet address information and approval information of the blockchain wallet. Thus, the user may mint, own, and trade non-fungible tokens without creating his or her own blockchain wallet or managing the wallet address information and approval information of the blockchain wallet.

FIG. 1B is a diagram for illustrating a process of minting a non-fungible token to a first blockchain wallet through the non-fungible token minting system 10 according to an embodiment of the present disclosure by the first user using the first user terminal 20_1.

As shown in FIG. 1B, the first user may input first token identification information UNQ_1 corresponding to an address at which a first non-fungible token is stored through the first user terminal 20_1 while the application installed in the first user terminal 20_1 is active. A method of inputting the first token identification information UNQ_1 through the first user terminal 20_1 includes: (i) a method of inputting the first token identification information UNQ_1 using an input device (e.g., a keypad) provided in the first user terminal 20_1; or (ii) a method of recognizing the token identification information UNQ_1 visualized and displayed on a tangible object (e.g., a physical card, etc.) (e.g., a barcode or QR code) through a recognition device (e.g., a camera) provided in the first user terminal 20_1. The token identification information UNQ_1 may be information (e.g., a serial number, etc.) to distinguish one non-fungible token from another non-fungible token.

The first user terminal 20_1 may transfer the input first token identification information UNQ_1 to the non-fungible token minting system 10. When the first token identification information UNQ_1 is received, the non-fungible token minting system 10 checks whether the non-fungible token corresponding to the first token identification information UNQ_1 has already been minted, and if not minted, first non-fungible token information NFT_1 stored at the address corresponding to the first token identification information UNQ_1 may be used to mint a non-fungible token to the first blockchain wallet corresponding to the first user identification information USER_1.

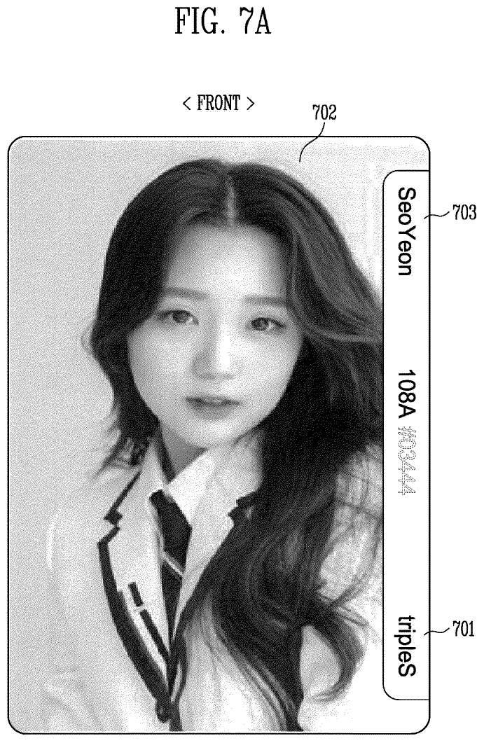

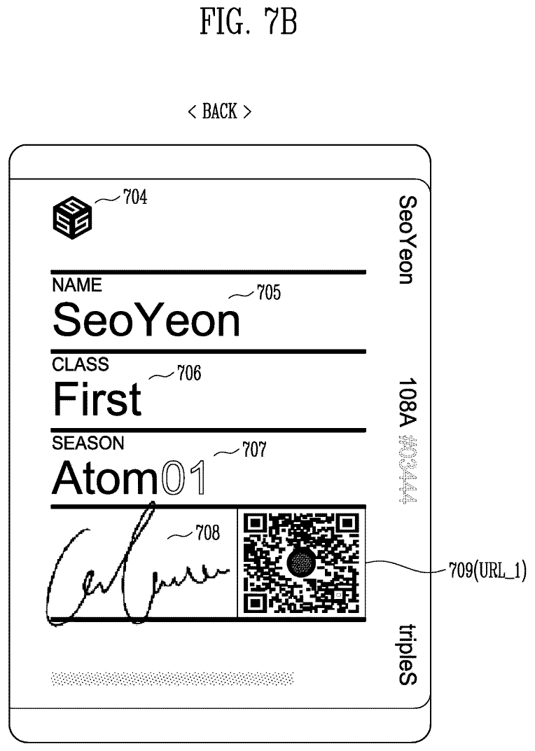

The first non-fungible token information NFT_1 may include first digital content information CON_1, which includes at least one of image data, sound source data, and video data, the first token identification information UNQ_1, and first token ID ID_1. One non-fungible token information NFT_1 may include digital content information CON_1, token identification information UNQ_1, and token ID ID_1 which correspond to each other. In addition, the first non-fungible token information NFT_1 may also include an Internet address at which the first digital content information CON_1 is stored, a name 701 of an idol group described in FIGS. 7A and 7B, a name of a member of the idol group 705, a class 706 arbitrarily determined of the non-fungible token, and a minting season 707.

When the first token identification information UNQ_1 is received, the non-fungible token minting system 10 may retrieve the non-fungible token information NFT_1 stored at the address corresponding to the token identification information UNQ_1 and the first wallet address information ADD_1 and the first approval information APP_1 matched to the first user identification information USER_1, and transfer the first wallet address information ADD_1 and the first token ID ID_1 included in the first non-fungible token information NFT_1 to a contract address of a smart contract of a non-fungible token existing on the blockchain network 30, thereby allowing the first wallet address information ADD_1 and the first token ID ID_1 to be recorded in a distributed ledger of the blockchain network 30. On the other hand, the non-fungible token minting system 10 may use the first approval information APP_1 to approve (or electronically sign) a transaction for transferring the first wallet address information ADD_1 and the first token ID ID_1 to the contract address of the smart contract of the non-fungible token existing on the blockchain network 30.

For reference, the smart contract of the non-fungible token may be authorized so that only a blockchain wallet of the administrator of the non-fungible token minting system 10 can request the transaction for minting of the non-fungible token, and therefore, in order to execute the transaction of the minting of the non-fungible token, the non-fungible token minting system may transfer the wallet address information of the blockchain wallet of the administrator of the non-fungible token minting system 10 together with the first wallet address information ADD_1 and the first token ID ID_1 to blockchain network 10 with the contract address of the smart contract of the non-fungible token.

The first token ID ID_1 may be recorded in a column describing the minted non-fungible token, and the first wallet address information ADD_1 may be recorded in a column describing an owner of the non-fungible token (see the distributed ledger in FIG. 1B). The content of the distributed ledger as described above may indicate that the first blockchain wallet having the first wallet address information ADD_1 owns the non-fungible token having the first token ID ID_1. Since the first blockchain wallet owns the non-fungible token with the first token ID ID_1 ‘for the first time’, this may mean that the non-fungible token with the first token ID ID_1 has been ‘minted’ to the first blockchain wallet.

In addition, although not shown in FIG. 1B, the non-fungible token minting system may transfer other information included in the first non-fungible token information NFT_1 (e.g., at least one of the Internet address at which the digital content information CON_1 is stored, the name of the idol group 701, the name of the member of the idol group 705, the class of the non-fungible token 706 arbitrarily determined, and the minting season 707) to the blockchain network in addition to the first token ID ID_1 and the first wallet address information ADD_1 to allow them to be recorded together with the first token ID ID_1 and the first wallet address information ADD_1.

Further, a fee (or gas fee) may be required to execute the transaction to mint the non-fungible token, and this fee may be transferred as a fungible token. The non-fungible token minting system 10 may transfer the fungible token used as the fee required to execute the transaction to mint the non-fungible token, so that the user's blockchain wallet does not have to directly transfer the fee, (i) from a wallet other than the first blockchain wallet minting the non-fungible token (e.g., the blockchain wallet of the administrator of the non-fungible token minting system), or (ii) to the first blockchain wallet prior to executing the transaction to mint the non-fungible token, or (iii) may check an amount of fungible tokens held in the first blockchain wallet so that the amount of fungible tokens held in the first blockchain wallet is maintained at a predetermined value and, when the amount of the fungible tokens is lower than the predetermined value, transfer the fungible token to the first blockchain wallet. Preferably, in the case of (i), the non-fungible token minting system 10 may execute the transaction to mint the non-fungible token to the first blockchain wallet in a wallet other than the first blockchain wallet (e.g., the blockchain wallet of the administrator of the non-fungible token minting system).

By using the non-fungible token minting system 10 through the application installed in the first user terminal 20_1, the user may mint the non-fungible token corresponding to the first non-fungible token information NFT_1 to the first blockchain wallet corresponding to the first user identification information USER_1 only by inputting the first token identification information UNQ_1 into the first user terminal 20_1.

When the minting of the non-fungible token corresponding to the first token identification information UNQ_1 is completed, the non-fungible token minting system 10 may store information indicating that the first token identification information UNQ_1 has already been used to mint the non-fungible token. In addition, the non-fungible token minting system 10 may store non-fungible token information stored by each blockchain wallet created through the application. For example, in the case that the non-fungible token corresponding to the first non-fungible token information NFT_1 is stored in the first blockchain wallet corresponding to the first user identification information USER_1, the non-fungible token minting system 10 may store information indicating it.

FIG. 1C is a diagram for explaining a process of checking a non-fungible token owned by the first blockchain wallet corresponding to the first user terminal 201 by the non-fungible token minting system 10 according to an embodiment of the present disclosure.

When token identification information corresponding to a non-fungible token that has already been minted is input, the non-fungible token minting system 10 cannot re-mint the non-fungible token. Therefore, the non-fungible token minting system 10 may confirm that the non-fungible token has already been minted to the user terminal that has input the corresponding token identification information.

As shown in FIG. 1C, the first user may input the first token identification UNQ_1 information corresponding to the address at which the first non-fungible token is stored through the first user terminal 20_1 while the application installed in the first user terminal 20_1 is active.

The first user terminal 20_1 may transfer the input first token identification information UNQ_1 to the non-fungible token minting system 10. When the first token identification information UNQ_1 is received, the non-fungible token minting system 10 may check whether the first token identification information UNQ_1 has already been used (i.e., whether the non-fungible token corresponding to the first token identification information UNQ_1 has already been minted), and when the first token identification information UNQ_1 has already been used (i.e., the non-fungible token corresponding to the first token identification information UNQ_1 has already been minted), may transfer confirmation information (CONFORM) indicating that the non-fungible token corresponding to the first token identification information UNQ_1 has already been minted to the first user terminal 20_1 without performing the operation of minting the non-fungible token as shown in FIG. 1C. The user of the first user terminal 201 may confirm that the non-fungible token corresponding to the first token identification information input to the first user terminal by the user has already been minted through the confirmation information (CONFORM). In other words, the non-fungible token minting system 10 may mint the non-fungible token corresponding to the input token identification information and then store the token identification information, and then, when the same token identification information is input, verify (or confirm) that the non-fungible token corresponding to the input token identification information has already been minted (i.e., an owner of the non-fungible token exist) using the stored information.

FIGS. 1D and 1E are diagrams for illustrating the ‘transfer’ operation of the non-fungible token of the non-fungible token minting system 10 according to an embodiment of the present disclosure.

A person to whom the non-fungible token is transferred, in other words, a user of a second user terminal 20_2, may be a user who installs the application in the second user terminal 20_2, registers second user identification information USER_2, and creates a second blockchain wallet. A process of creating the second blockchain wallet and a process of matching and storing second wallet address information ADD_2 and second approval information APP_2 of the second blockchain wallet to the second user identification information USER_2 are the same as those described with respect to FIG. 1A and thus are omitted.

In addition, ‘transfer’ of the non-fungible token assumes that the non-fungible token has been ‘minted’, and a ‘minting’ operation of the non-fungible token performed before the ‘transfer’ of the non-fungible token is the same as the ‘minting’ operation of the non-fungible token are the same as those described with respect to FIG. 1B and thus are omitted.

The non-fungible token minting system 10 according to an embodiment of the present disclosure may transfer the non-fungible token stored in the first blockchain wallet from the first blockchain wallet to the second blockchain wallet by: (i) by receiving the first user identification information USER_1 while the application is activated in the first user terminal 20_1, and then inputting the second user identification information USER_2 of the person to whom the non-fungible token is to be transferred (the user using the second user terminal 20_2, the owner of the second blockchain wallet) to the first user terminal 20_1 and approving transfer of the non-fungible token at the first user terminal (see FIG. 1D and its description below); or (ii) by receiving the first token identification information UNQ_1 while activating the application installed in the second user terminal 20_2, and then approving the transfer of the non-fungible token at the first user terminal 201 (see FIG. 1E and its description below).

As shown in FIG. 1D, the first user may input the first user identification information USER_1 while the application installed in the first user terminal 20_1 is activated, and then input the second user identification information USER_2 of the second user to whom the non-fungible token is to be transferred to the first user terminal 20_1 and allow the transfer of the non-fungible token, thereby capable of transferring the non-fungible token from the first blockchain wallet to the second blockchain wallet.

When the first user activates the application in the first user terminal 20_1 and inputs the first user identification information USER_1, the first user terminal 20_1 may transfer the first user identification information USER_1 to the non-fungible token minting system 10, and the non-fungible token minting system 10 may transfer the first wallet address information ADD_1 corresponding to the first user identification information USER_1 to the first user terminal 20_1 (i.e., the first user terminal 201 may retrieve the first wallet address information ADD_1). Here, the process of the first user activating the application in the first user terminal 20_1 and inputting the first user identification information USER_1 to retrieve the first non-fungible token information NFT_1 and the first wallet address information ADD_1 is a preliminary operation for transferring the non-fungible token, and may be an operation of logging in to a service provided by the non-fungible token minting system 10.

At the time of the above login operation, the first user terminal 20_1 may retrieve some or all of the first non-fungible token information NFT_1 of the first non-fungible token stored by the first blockchain wallet from the non-fungible token minting system 10 ((1)) or from the blockchain network 30 ((2)). In the case of (2), a command to retrieve some or all of the first non-fungible token information NFT_1 of the first non-fungible token to the first user terminal 20_1 may be transferred by the non-fungible token minting system 10 to the blockchain network 30 or transferred directly by the first user terminal 20_1.

The first user may input the second user identification information USER_2 to the first user terminal 20_1 to transfer the non-fungible token, the first user terminal 20_1 may transfer the input second user identification information USER_2 to the non-fungible token minting system 10, and the non-fungible token minting system 10 may transfer the second wallet address information ADD_2 stored by matching with the second user identification information USER_2 to the first user terminal 201 (i.e., the first user terminal 20_1 may receive the second user identification information USER_2 to retrieve the first wallet address information ADD_2).

The first user may transfer the first token ID ID_1 included in the first non-fungible token information NFT_1, the first wallet address information ADD_1, and the second wallet address information ADD_2 to the contract address of the smart contract of the non-fungible token existing on the blockchain network 30 through the first user terminal 20_1 to allow the second wallet address information ADD_2 and the first token ID ID_1 to be recorded in the distributed ledger of the blockchain network 30. On the other hand, the first user terminal 20_1 may retrieve the first approval information APP_1 through the non-fungible token minting system 10 and approve (or electronically sign) a transaction to transfer the first wallet address information ADD_1, the second wallet address information ADD_2, and the first token ID ID_1 to the contract address of the smart contract of the non-fungible token existing on the blockchain network 30 using it.

For reference, the smart contract of the non-fungible token may be authorized so that only the owner of the blockchain wallet currently holding the non-fungible token can request the transaction of the transfer of the non-fungible token, and therefore, in order to execute the transaction of the minting of the non-fungible token, the non-fungible token minting system 10 may transfer the first wallet address information ADD_1 of the first blockchain wallet currently holding the non-fungible token to be transferred to the contract address of the smart contract of the non-fungible token, the second wallet address information ADD_2, and the first token ID ID_1 together to the blockchain network 10.

The second wallet address information ADD_2 may be recorded in a column describing an owner of the non-fungible token (see the distributed ledger in FIG. 1D). The content of the distributed ledger as described above may indicate that the second blockchain wallet having the second wallet address information ADD_2 owns the non-fungible token having the first token ID ID_1. Since the owner of the non-fungible token having the first token ID ID_1 has changed from the first blockchain wallet to the second blockchain wallet through the above transaction, this may mean that the non-fungible token having the first token ID ID_1 has been ‘transferred’ from the first blockchain wallet to the second blockchain wallet.

On the other hand, a fee (or gas fee) may be required to execute the transaction to transfer the non-fungible token, and the above fee may be transferred as a fungible token. The non-fungible token minting system 10 may (i) transfer the fungible token used as the fee required to execute the transaction to mint the non-fungible token to the first blockchain wallet prior to executing the transaction to mint the non-fungible token, or (ii) check an amount of fungible tokens held in the first blockchain wallet so that the amount of fungible tokens held in the first blockchain wallet is maintained at a predetermined value and, when the amount of the fungible tokens is lower than the predetermined value, transfer the fungible token to the first blockchain wallet, so that the user's blockchain wallet does not have to directly transfer the fee.

By using the non-fungible token minting system 10 through the application installed in the first user terminal 201, the user may transfer the non-fungible token corresponding to the first non-fungible token information NFT_1 stored in the first blockchain wallet corresponding to the first user identification information USER_1 to the second blockchain wallet corresponding to second user identification information USER_2 only by inputting the second user identification information USER_2 into the first user terminal 20_1 and approving the transaction to transfer the non-fungible token.

As shown in FIG. 1E, after the second user inputs the first token identification information UNQ_1 to the second user terminal 20_2 while the application installed in the second user terminal 20_2 is active, the first user may approve the transfer of the non-fungible token while the application installed in the first user terminal 20_1 is active to transfer the non-fungible token from the first blockchain wallet to the second blockchain wallet. The method of transferring the non-fungible token by the non-fungible token minting system 10 of FIG. 1E is exactly the same as the method of transferring the non-fungible token by the non-fungible token minting system 10 illustrated in the description of FIG. 1D, except that the first token identification information UNQ_1 is received through the second user terminal 20_2, and finally, approval of transfer of the non-fungible token is requested to the first user terminal 20_1. Therefore, description of the same operation as that of the non-fungible token minting system 10 shown in FIG. 1D is omitted below.

For reference, a method of inputting the first token identification information UNQ_1 to the second user terminal 20_2 may be the same as the method of inputting the first token identification information UNQ_1 to the first user terminal 20_1 described in FIG. 1A.

When the second user inputs the first token identification information UNQ_1 to the second user terminal 20_2 while the application installed in the second user terminal 20_2 is active, the second user terminal 20_2 may transfer the first token identification information UNQ_1 to the non-fungible token minting system 10. Upon receiving the first token identification information UNQ_1, the non-fungible token minting system 10 may determine whether a non-fungible token corresponding to the first token identification information UNQ_1 has already been minted. If the non-fungible token has already been minted, the non-fungible token minting system 10 may check whether the blockchain wallet storing the non-fungible token corresponding to the first token identification information UNQ_1 is the second blockchain wallet. If the non-fungible token is not stored in the second blockchain wallet, the non-fungible token minting system 10 may request approval (or digital signature) of a transaction to transfer the non-fungible token to the first user terminal 20_1 in which the non-fungible token is stored (REQ_APP). The non-fungible token minting system 10 may transfer the second wallet address information ADD_2 corresponding to the second blockchain wallet requesting the transfer of the non-fungible token together with the above request REQ_APP.

Alternatively, the second user may input the first token identification information UNQ_1 to the second user terminal 20_2, and in the case that the non-fungible token corresponding to the first token identification information UNQ_1 has already been minted and the non-fungible token is not stored in the second blockchain wallet, the second user may request transfer of the non-fungible token (REQ_TR) to the non-fungible token minting system 10. When the request REQ_TR is received from the second user terminal 20_2, the non-fungible token minting system 10 may transfer a request for approval of the transaction REQ_APP to the first user terminal 20_1. Alternatively, the second user may directly input the request REQ_TR for the transfer of the non-fungible token to the second user terminal 20_2.

The non-fungible token minting system 10 may transfer the second wallet address information ADD_2 corresponding to the second blockchain wallet requesting the transfer of the non-fungible token together with the request for approval REQ_APP.

When the first user approves the transaction to transfer the non-fungible token corresponding to the first token identification information UNQ_1 from the first blockchain wallet to the second blockchain wallet through the first user terminal 20_1, the first user terminal 20_1 may transfer the first wallet address information ADD_1, the second wallet address information ADD_2, and the first token ID ID_1 to the blockchain network 30 to transfer the non-fungible token corresponding to the first token ID ID_1 stored in the first blockchain wallet from the first blockchain wallet to the second blockchain wallet.

As such, using the non-fungible token minting system 10 according to an embodiment of the present disclosure, the user may install the application on his or her user terminal (20_1 or 20_2) and register as a user of the application to mint, check, and transfer the non-fungible token. In other words, the user may easily mint, own, and transfer the non-fungible token through the non-fungible token minting system 10 without going through complex or legally restricted processes such as opening a bank account, registering with an exchange, and creating a personal blockchain wallet. Using the non-fungible token minting system 10 according to an embodiment of the present disclosure, non-fungible tokens may be freely traded directly between users without using an existing coin or token trading website. In other words, the non-fungible token minting system 10 may also act as an exchange.

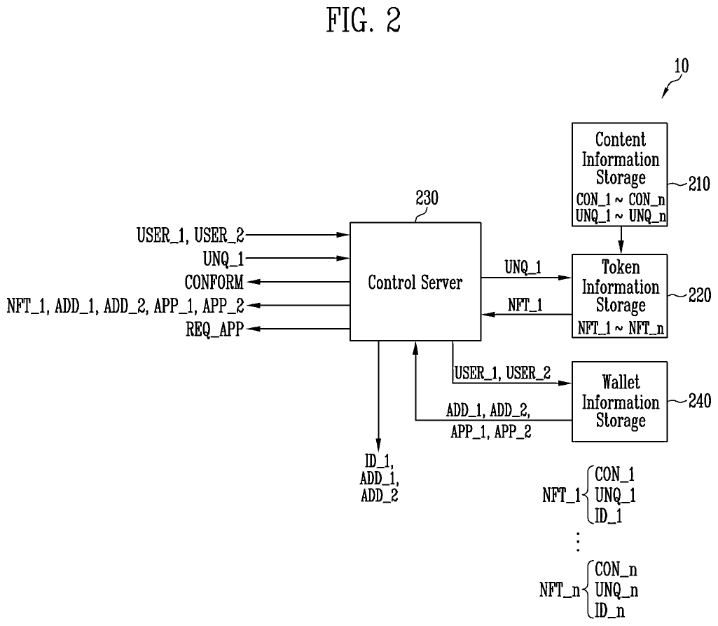

FIG. 2 is a block diagram illustrating an overall configuration of the non-fungible token minting system 10 according to an embodiment of the present disclosure.

As shown in FIG. 2, the non-fungible token minting system 10 may include a content information storage 210, a token information storage 220, and a control server 230. The non-fungible token minting system 10 according to an embodiment of the present disclosure may further include a wallet information storage 240.

The content information storage 210 may store at least one digital content information (CON_1˜CON_n, n is a natural number) including one or more kinds of data of image data, sound source data, and video data that are contents of a non-fungible token. At least one digital content information CON_1˜CON_n may be data stored and preserved in an external storage medium other than the blockchain network 30 as an original digital content of the non-fungible token itself. At least one digital content information CON_1˜ CON_n stored in the content information storage 210 may be digital content information corresponding to unique non-fungible tokens, respectively. In addition to the digital content information, the content information storage 210 may further store at least one token identification information UNQ_1˜UNQ_n assigned to identify at least one non-fungible token, respectively. The token identification information may be, for example, serial numbers having different values assigned to different non-fungible tokens.

The token information storage 220 may store at least one non-fungible token information NFT_1˜NFT_n including at least one digital content information CON_1˜CON_n, at least one token identification information UNQ_1˜UNQ_n, and at least one token ID ID_1˜ID_n, and each non-fungible token information (NFT_1˜NFT_n) may be stored at an address corresponding to the token identification information (UNQ_1˜UNQ_n) that it includes in the token information storage 220. Each of at least one non-fungible token information NFT_1˜NFT_n may correspond to a unique non-fungible token. Some or all of information included in at least one non-fungible token information NFT_1˜NFT_n may be information transferred to and recorded in the blockchain network 30 when the non-fungible token is minted. For example, among at least one non-fungible token information NFT_1˜NFT_n, the information transferred to and recorded in the blockchain network 30 may include each token ID ID_1˜ID_n. In addition, the non-fungible token information (NFT_1˜NFT_n) may also include various kinds of information such as an Internet address where the digital content information (CON_1˜CON_n) is stored, the name of the idol group 701 described in FIGS. 7A and B, the name of the idol group member 705, the class of the non-fungible token 706 arbitrarily determined, and the minting season 707.

At least one token identification information UNQ_1˜UNQ_n is text information itself including one or more numbers, letters, and symbols for identifying the non-fungible token, or the above text information and information obtained by converting the text information into a two-dimensional barcode or QR code, or information including a URL and a barcode or QR code obtained by converting the URL. At least one token identification information UNQ_1˜UNQ_n may be displayed on a tangible object (e.g., a physical card), and the user terminal (20_1 or 20_2) may recognize at least one token identification information UNQ_1˜UNQ_n displayed on the tangible object to receive at least one token identification information UNQ_1˜UNQ_n. A method in which the user terminal (20_1 or 20_2) receives at least one token identification information UNQ_1˜UNQ_n may include: (i) a method of receiving at least one token identification information UNQ_1˜UNQ_n, which is text information, through an input device (e.g., a keypad) provided in the user terminal; and (ii) a method of receiving at least one token identification information UNQ_1˜UNQ_n by recognizing the barcode or QR code through a recognition device (e.g., a camera) provided in the user terminal.

When the user installs the application on the user terminal (20_1 or 20_2) and registers himself or herself as the application user, and registers the user identification information (USER_1 or USER_2), the control server 230 may create the first or second blockchain wallet corresponding to each user identification information (USER_1 or USER_2). The control server 230 may store the first and second user identification information (USER_1 and USER_2) by matching the information with the first and second wallet address information (ADD_1 and ADD_2) of the first and second blockchain wallets and the first and second approval information (APP_1, APP_2) or allow the information to be stored by matching them with each other. The first and second user identification information (USER_1 and USER_2), the first and second wallet address information (ADD_1 and ADD_2) of the first and second blockchain wallets, and the first and second approval information (APP_1 and APP_2) may all be stored in the same server or on different servers. FIG. 2 shows the case where the first and second wallet address information (ADD_1 and ADD_2) and the first and second approval information (APP_1 and APP_2) are all stored in the wallet information storage 240, and the wallet information storage 240 is included in the non-fungible token minting system 10, but the wallet information storage 240 may be an external configuration that is not included in the non-fungible token minting system 10 or may itself be a server device capable of communication. The first user identification information USER_1, the first wallet address information ADD_1 and the first approval information APP_1 are matched and stored, and the second user identification information USER_2, the second wallet address information ADD_2, and the second approval information APP_2 may be matched and stored.

When necessary for minting and transfer of non-fungible tokens, the control server 230 may retrieve (i) the non-fungible token information NFT_1˜NFT_n stored at the addresses corresponding to the token identification information from the token information storage 220 using the token identification information UNQ_1˜UNQ_n, and (ii) the wallet address information (ADD_1 or ADD_2) and approval information (APP_1 or APP_2) matched with the user identification information (USER_1 or USER_2) from the wallet information storage 240 using the user identification information. For example, the control server 230 may retrieve the first non-fungible token information NFT_1 from the token information storage 220 using the first token identification information UNQ_1, and retrieve the first wallet address information ADD_1 and the first approval information APP_1 from the wallet information storage 240 using the first user identification information USER_1.

The control server 230 may transfer the token identification information (UNQ_1˜UNQ_n), the wallet address information (ADD_1, ADD_2), and the approval information (APP_1, APP_2) to the user terminal (20_1, 20_2) when necessary for minting and transfer of non-fungible tokens.

The control server 230 may check whether the non-fungible token corresponding to the first token identification information UNQ_1 has already been minted, and if minted, check whether the blockchain wallet holding the non-fungible token corresponding to the first token identification information UNQ_1 is the second blockchain wallet, and then, check whether the non-fungible token corresponding to the first token identification information UNQ_1 is stored in the second blockchain wallet. If the non-fungible token is not stored in the second blockchain wallet, the control server 230 may request approval (or electronic signature) of the transaction to transfer the non-fungible token to the first user terminal 20_1 in which the non-fungible token is stored (REQ_APP). Alternatively, the control server 230 may receive the request REQ_TR for the transfer of the non-fungible token from one user terminal (20_2, a user terminal corresponding to a blockchain wallet to receive the non-fungible token) and transfer the request REQ_APP for approval (or electronic signature) of the transaction to transfer the non-fungible token to another user terminal (20_1, a user terminal corresponding to a blockchain wallet to transfer the non-fungible token). In other words, the request REQ_APP for approval of the transaction to transfer the non-fungible token transferred to the first user terminal (20_1, the user terminal corresponding to the blockchain wallet to transfer the non-fungible token) may be made by the control server 230 itself, or may be for delivering the request REQ_TR for transfer of the second user terminal (20_2, the user terminal corresponding to the blockchain wallet to receive the non-fungible token).

When minting a non-fungible token, the control server 230 may transfer the token ID corresponding to the minted non-fungible token and the wallet address information to which the non-fungible token is to be minted to the blockchain network 30 to execute a transaction for minting the non-fungible token. In the descriptions of FIGS. 1D and 1E, the first user terminal 20_1 executes the transaction for transferring the non-fungible token, but the control server 230 may execute the transaction for transferring the non-fungible token.

When the user inputs token identification information while the application is activated in the user terminal and a non-fungible token is minted using the token identification information, the control server 230 may store information indicating it. Then, the control server 230 may receive the token identification information input through the user terminal, and in the case that the received token identification information has already been minted (i.e., already used), transfer information indicating that the non-fungible token corresponding to the token identification information has already been minted (CONFORM) to the user terminal.

The control server 230 may (i) transfer a fungible token used as a fee required to execute the transaction to mint the non-fungible token from a wallet other than the first blockchain wallet minting the non-fungible token (e.g., the blockchain wallet of the administrator of the non-fungible token minting system) (preferably, the transaction to mint the non-fungible token is executed in the blockchain wallet of the administrator), (ii) transfer a token used as a fee required to execute the transaction to mint or transfer the non-fungible token to the blockchain wallet executing the transaction to mint or transfer the non-fungible token prior to executing the transaction, or (iii) check an amount of fungible tokens held in the blockchain wallet so that the amount of fungible tokens required to execute the transaction to mint or transfer the non-fungible token held in the blockchain wallet is maintained at a predetermined value and, when the amount of the fungible tokens is lower than the predetermined value, transfer the fungible token to the first blockchain wallet.

When the first and second blockchain wallets are created, the wallet information storage 240 may store the first and second wallet address information (ADD_1, ADD_2) and the first and second approval information (APP_1, APP_2) matched to the first and second user identification information (USER_1, USER_2) corresponding to the created blockchain wallets. Here, the wallet information storage 240 may encrypt and store the first and second approval information (APP_1, APP_2) used for approval (or electronic signature) of transactions so that the first and second approval information are not leaked. The wallet information storage 240 may transfer the first and second approval information (APP_1, APP_2) to the control server 230 according to a call of the control server 230 when the control server 230 performs the transaction to mint or transfer the non-fungible token.

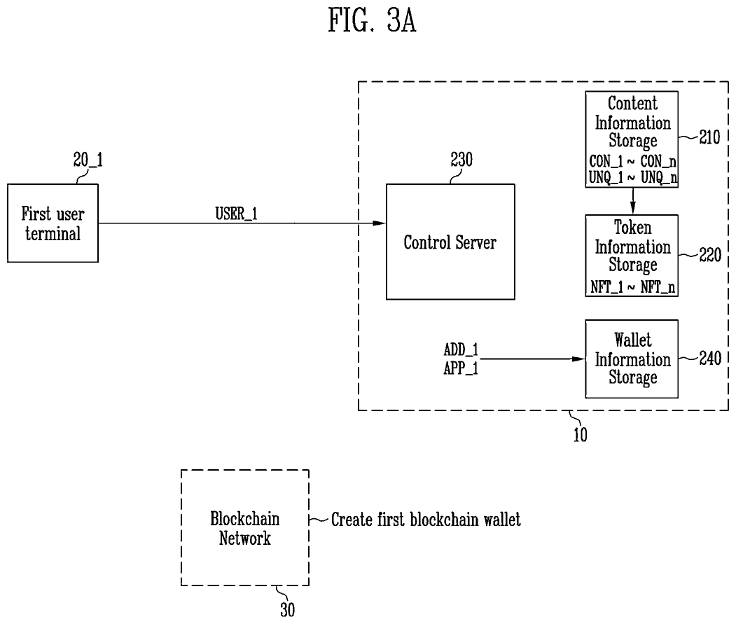

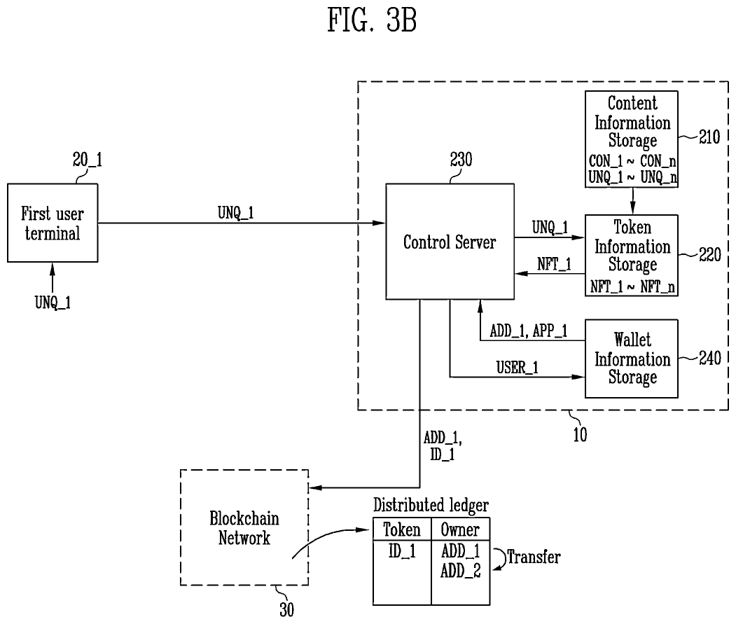

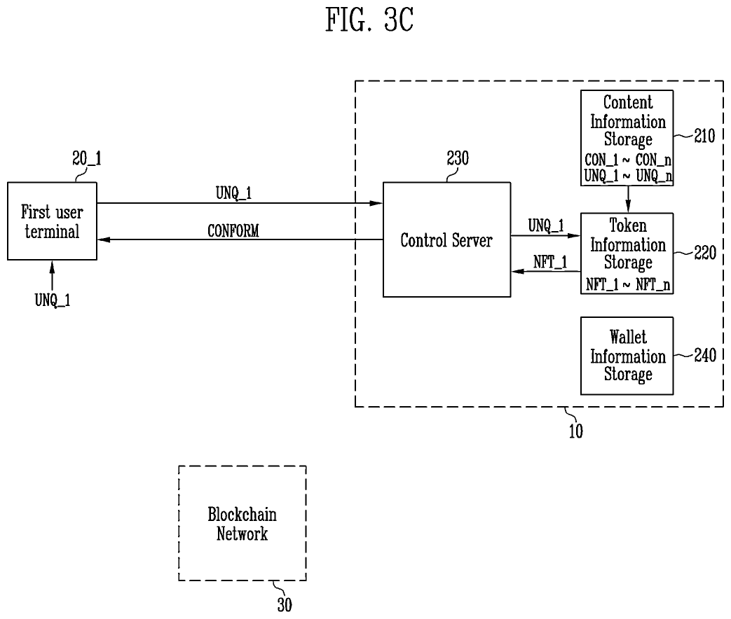

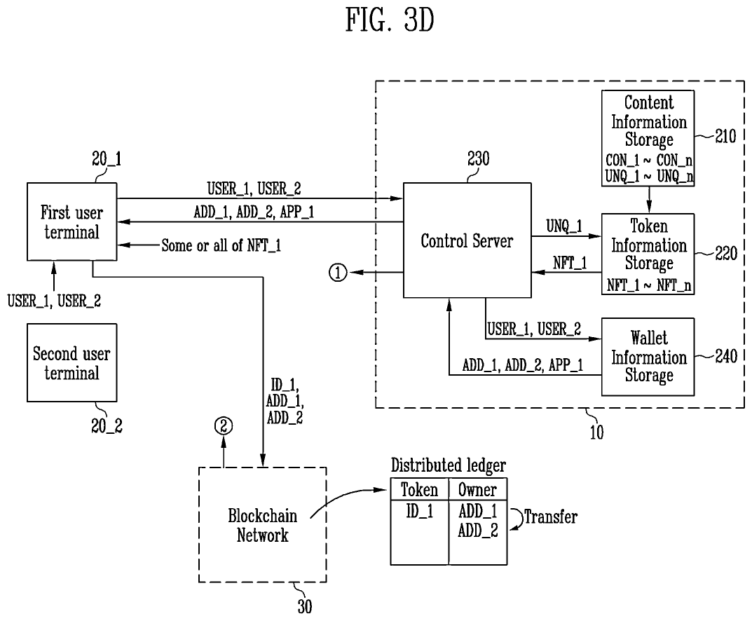

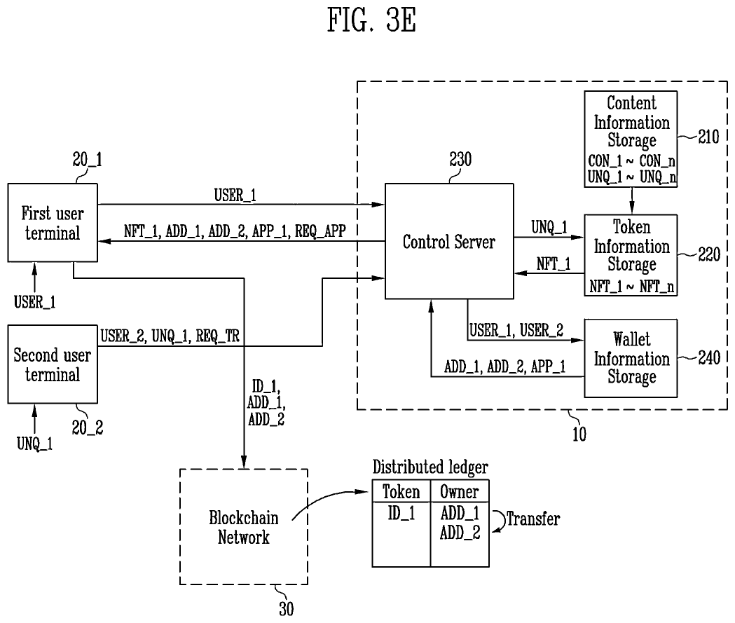

FIGS. 3A to 3E are diagrams for illustrating operations of the non-fungible token minting system 10 according to an embodiment of the present disclosure.

FIG. 3A is a diagram for illustrating a process of creating the first blockchain wallet through the non-fungible token minting system 10 according to an embodiment of the present disclosure by the first user using the first user terminal 20_1.

As shown in FIG. 3A, the first user may install the application necessary for minting, checking, and transferring the non-fungible token using the non-fungible token minting system 10 at the first user terminal 20_1, and execute the application on the first user terminal 20_1 to register himself or herself as the user of the application. While registering himself or herself as the user of the application, the first user may register the first user identification information (USER_1, e.g., the e-mail address of the first user, the first nickname directly input by the first user, etc.) that can identify the user with other users of the application. The first user terminal 20_1 may transfer the first user identification information USER_1 to the control server 230.

When the first user registers the first user identification information USER_1, the control server 230 may create the first blockchain wallet used to mint, store, and transfer the non-fungible token in the blockchain network 30, and receive the first user identification information USER_1 transferred by the first user terminal 20_1 and store the first wallet address information ADD_1 and the first approval information APP_1 of the first blockchain wallet in the wallet information storage 240 by matching with the first user identification information USER_1.

FIG. 3A illustrates the case in which the first user identification information USER_1 is stored in the control server 230, and the first wallet address information ADD_1 and the first approval information APP_1 are stored in the wallet information storage 240. However, the first user identification information USER_1, the first wallet address information ADD_1, and the first approval information APP_1 may all be stored in the control server 230, or they may all be stored in the wallet information storage 240, or they may be stored separately in different storages or servers. In addition, the first user identification information USER_1, the first wallet address information ADD_1, and the first approval information APP_1 may be stored in duplicate. For example, the first user identification information USER_1 and the first wallet address information ADD_1 may be stored in the control server 230 and the first user identification information USER_1 and the first approval information APP_1 may be stored in the wallet information storage 240, and thus the first user identification information USER_1 may be stored redundantly in the control server 230 and the wallet address storage 240. In addition, the first user identification information USER_1, the first wallet address information ADD_1, and the first approval information APP_1 may all be encrypted and stored for security, or only some of the above information may be encrypted and stored. FIG. 3A shows the case in which the wallet information storage 240 is included in the non-fungible token minting system 10, but the wallet information storage 240 may be a storage or server that exists outside of the non-fungible token minting system 10 and may be a server managed by an entity other than the operator of the non-fungible token minting system 10 that provides Software-as-a-Service (SaaS).

When the user installs the application in the user terminal and registers himself or herself as the user of the application and inputs only the user identification information to distinguish himself or herself from other users, the non-fungible token minting system 10 automatically creates the blockchain wallet corresponding to the user identification information and manages the wallet address information and approval information of the blockchain wallet. Therefore, the user may mint, own, and trade the non-fungible token without creating his or her own blockchain wallet or managing the wallet address information and approval information of the blockchain wallet.

FIG. 3B is a diagram for illustrating a process of minting a non-fungible token to the first blockchain wallet through the non-fungible token minting system 10 according to an embodiment of the present disclosure using the first user terminal 20_1.

As shown in FIG. 3B, the first user may input the first token identification information UNQ_1 corresponding to the address at which the first non-fungible token is stored through the first user terminal 20_1 while the application installed in the first user terminal 20_1 is active. A method of inputting the first token identification information UNQ_1 through the first user terminal 20_1 includes: (i) a method of directly inputting the first token identification information UNQ_1 using an input device (e.g., a keypad) provided in the first user terminal 20_1; or (ii) a method of recognizing the token identification information UNQ_1 visualized and displayed on the tangible object (e.g., a physical card, etc.) (e.g., a barcode or QR code) through the recognition device (e.g., a camera) provided in the first user terminal 20_1.

The first user terminal 20_1 may transfer the input first token identification information UNQ_1 to the control server 230. When the first token identification information UNQ_1 is received, the control server 230 may check whether a non-fungible token corresponding to the first token identification information UNQ_1 has already been minted, and if not minted, transfer the first token identification information UNQ_1 to the token information storage 220 to retrieve the first non-fungible token information NFT_1 stored at the address corresponding to the first token identification information UNQ_1 from the token information storage 220. In addition, the control server 230 may transfer the first user identification information USER_1 to the wallet information storage 240 to retrieve the first wallet address information ADD_1 and the first approval information APP_1 stored to be matched to the first user identification information USER_1 from the wallet information storage 240.

When the first non-fungible token information NFT_1, the first wallet address information ADD_1, and the first approval information APP_1 are received, the control server 230 may transfer the first wallet address information ADD_1 and the first token ID ID_1 included in the first non-fungible token information NFT_1 to the contract address of the smart contract of the non-fungible token existing on the blockchain network 30, thereby allowing the first wallet address information ADD_1 and the first token ID ID_1 to be recorded in a distributed ledger of the blockchain network 30.

In addition, although not shown in FIG. 3B, the non-fungible token minting system may transfer other information included in the first non-fungible token information NFT_1 (e.g., at least one of the Internet address at which the digital content information CON_1 is stored, the name of the idol group 701, the name of the member of the idol group 705, the class of the non-fungible token 706 arbitrarily determined, and the minting season 707) to the blockchain network in addition to the first token ID ID_1 and the first wallet address information ADD_1 to allow them to be recorded together with the first token ID ID_1 and the first wallet address information ADD_1.

Further, the control server 230 may use the first approval information APP_1 to approve (or electronically sign) a transaction to transfer the first wallet address information ADD_1 and the first token ID ID_1 to the contract address of the smart contract of the non-fungible token existing on the blockchain network 30. On the other hand, the content recorded in the distributed ledger when the non-fungible token is minted and its meaning are the same as those described above with respect to FIG. 1B, so they are omitted.

A fee (or gas fee) may be required to execute a transaction to mint the non-fungible token, and this fee may be transferred as a fungible token. The control server 230 may transfer the token used as the fee required to execute the transaction to mint the non-fungible token, so that the user's blockchain wallet does not have to directly transfer the fee, (i) from a wallet other than the first blockchain wallet minting the non-fungible token (e.g., the blockchain wallet of the administrator of the non-fungible token minting system), or (ii) to the first blockchain wallet prior to executing the transaction to mint the non-fungible token, or (iii) may check an amount of fungible tokens held in the first blockchain wallet so that the amount of fungible tokens held in the first blockchain wallet is maintained at a predetermined value and, when the amount of the fungible tokens is lower than the predetermined value, transfer the fungible token to the first blockchain wallet. Preferably, in the case of (i), the control server 230 may execute the transaction to mint the non-fungible token to the first blockchain wallet in a wallet other than the first blockchain wallet (e.g., the blockchain wallet of the administrator of the non-fungible token minting system).

The user may use the non-fungible token minting system 10 through the application installed in the first user terminal 20_1 to mint the non-fungible token corresponding to the first non-fungible token information NFT_1 to the first blockchain wallet corresponding to the first user identification information USER_1 simply by inputting the first token identification information UNQ_1 to the first user terminal 20_1.

When the minting of the non-fungible token corresponding to the first token identification information UNQ_1 is completed, the control server 230 may store information indicating that the first token identification information UNQ_1 has already been used to mint the non-fungible token. In addition, the control server 230 may store the non-fungible token information stored by each blockchain wallet generated through the application. For example, the control server 230 may store information indicating that the non-fungible token corresponding to the first non-fungible token information NFT_1 is stored in the first blockchain wallet corresponding to the first user identification information USER_1.

FIG. 3C is a diagram for checking a non-fungible token in possession of the first blockchain wallet corresponding to the first user terminal 20_1 in the non-fungible token minting system 10 according to an embodiment of the present disclosure.

When token identification information corresponding to a non-fungible token that has already been minted is input, the control server 230 cannot re-mint the non-fungible token. Therefore, the user terminal inputting the token identification information may confirm that the non-fungible token has already been minted.

As shown in FIG. 3C, the first user may input the first token identification information UNQ_1 corresponding to the address at which the first non-fungible token is stored through the first user terminal 20_1 while the application installed in the first user terminal 20_1 is active.

The first user terminal 20_1 may transfer the input first token identification information UNQ_1 to the control server 230. When the first token identification information UNQ_1 is received, the control server 230 may check whether the first token identification information UNQ_1 has already been used (i.e., the non-fungible token corresponding to the first token identification information UNQ_1 has already been minted), and when the first token identification information UNQ_1 has already been used (i.e., a non-fungible token corresponding to the first token identification information UNQ_1 has already been minted), the control server 230 may not perform an operation to mint the non-fungible token as shown in FIG. 3B and transfer confirmation information (CONFORM) indicating that the non-fungible token corresponding to the first token identification information UNQ_1 has already been minted to the first user terminal 20_1. The user of the first user terminal 20_1 may confirm that the non-fungible token corresponding to the first token identification information UNQ_1 input to the first user terminal 20_1 has already been minted through the confirmation information CONFORM. In other words, the control server 230 may mint the non-fungible token corresponding to the input token identification information and then store the token identification information. Then, when the same token identification information is input, it is possible to verify (or confirm) that the non-fungible token corresponding to the input token identification information has already been minted (i.e., an owner of the non-fungible token exists) using the information stored as above.

FIGS. 3D and 3E are drawings for illustrating the ‘transfer’ operation of the non-fungible token of the non-fungible token minting system 10 according to an embodiment of the present disclosure.

The person to whom the non-fungible token is transferred, in other words, the user of the second user terminal 202, may be a user who installs the application in the second user terminal 20_2, registers the second user identification information USER_2, and creates the second blockchain wallet. A process of creating the second blockchain wallet and a process of matching and storing the second wallet address information ADD_2 and the second approval information APP_2 of the second blockchain wallet to the second user identification information USER_2 are the same as those described in FIG. 3A and thus are omitted.

In addition, the ‘transfer’ of the non-fungible token assumes that the non-fungible token has been ‘minted’, and a ‘minting’ operation of the non-fungible token performed before the ‘transfer’ of the non-fungible token is the same as the ‘minting’ operation of the non-fungible token described in FIG. 3B and thus is omitted.

The non-fungible token minting system 10 according to an embodiment of the present disclosure may transfer the non-fungible token stored in the first blockchain wallet from the first blockchain wallet to the second blockchain wallet by: (i) by receiving the first user identification information USER_1 while the application is activated in the first user terminal 20_1, and then inputting the second user identification information USER_2 of the person to whom the non-fungible token is to be transferred (the user using the second user terminal 20_2, the owner of the second blockchain wallet) to the first user terminal 20_1 and approving transfer of the non-fungible token at the first user terminal (see FIG. 3D and its description below); or (ii) by receiving the first token identification information UNQ_1 while activating the application in the second user terminal 20_2, and then approving the transfer of the non-fungible token at the first user terminal 201 (see FIG. 3E and its description below).

As shown in FIG. 3D, the first user may input the first user identification information USER_1 while the application installed in the first user terminal 120_1 is active, then input the second user identification information USER_2 of the second user to whom the non-fungible token is to be transferred to the first user terminal 20_1, and approve the transfer of the non-fungible token to transfer the non-fungible token from the first blockchain wallet to the second blockchain wallet.

When the first user activates the application in the first user terminal 20_1 and inputs the first user identification information USER_1, the first user terminal 20_1 may transfer the first user identification information USER_1 to the control server 230, and the control server 230 may transfer the first wallet address information ADD_1 corresponding to the first user identification information USER_1 to the first user terminal 20_1 (i.e., when the first user terminal 201 inputs the first wallet address information ADD_1, the control server 230 may transfer the first wallet address information ADD_1 to the first user terminal 20_1). Here, the process of the first user activating the application in the first user terminal 20_1 and inputting the first user identification information USER_1 to retrieve the first non-fungible token information NFT_1 and the first wallet address information ADD_1 is a preliminary operation for transferring the non-fungible token, and may be an operation of logging in to a service provided by the non-fungible token minting system 10.

At the time of the above login operation, the first user terminal 20_1 may retrieve some or all of the first non-fungible token information NFT_1 of the first non-fungible token stored by the first blockchain wallet from the non-fungible token minting system 10 ((1)) or from the blockchain network 30 ((2)). In the case of (2), a command to retrieve some or all of the first non-fungible token information NFT_1 of the first non-fungible token to the first user terminal 20_1 may be transferred by the non-fungible token minting system 10 to the blockchain network 30 or transferred directly by the first user terminal 20_1.

The first user may input the second user identification information USER_2 to the first user terminal 20_1 to transfer the non-fungible token, the first user terminal 20_1 may transfer the input second user identification information USER_2 to the control server 230, and the control server 230 may retrieve the second wallet address information ADD_2 stored by matching with the second user identification information USER_2 from the wallet information storage 240 and transfer it to the first user terminal 20_1.

The first user may transfer the first token ID ID_1 included in the first non-fungible token information NFT_1, the first wallet address information ADD_1, and the second wallet address information ADD_2 to the contract address of the smart contract of the non-fungible token existing on the blockchain network 30 through the first user terminal 20_1 to allow the second wallet address information ADD_1 and the first token ID ID_1 to be recorded in the distributed ledger of the blockchain network 30. On the other hand, the first user terminal 20_1 may retrieve the first approval information APP_1 through the control server 230 and approve (or electronically sign) a transaction to transfer the first wallet address information ADD_1, the second wallet address information ADD_2 and the first token ID ID_1 to the contract address of the smart contract of the non-fungible token existing on the blockchain network 30 using it. On the other hand, the content recorded in the distributed ledger when the non-fungible token is minted and its meaning are the same as those described above with respect to FIG. 1B, so they are omitted.

A fee (or gas fee) may be required to execute a transaction to mint the non-fungible token, and this fee may be transferred as a fungible token. The control server 230 may (i) transfer the fungible token used as the fee required to execute the transaction to mint the non-fungible token to the first blockchain wallet prior to executing the transaction to mint the non-fungible token, or (ii) check an amount of fungible tokens held in the first blockchain wallet so that the amount of fungible tokens held in the first blockchain wallet is maintained at a predetermined value and, when the amount of the fungible tokens is lower than the predetermined value, transfer the fungible token to the first blockchain wallet, so that the user's blockchain wallet does not have to directly transfer the fee.

By using the non-fungible token minting system 10 through the application installed in the first user terminal 201, the user may transfer the non-fungible token corresponding to the first non-fungible token information NFT_1 stored in the first blockchain wallet corresponding to the first user identification information USER_1 to the second blockchain wallet corresponding to second user identification information USER_2 only by inputting the second user identification information USER_2 into the first user terminal 20_1 and approving the transaction to transfer the non-fungible token.

As shown in FIG. 3E, after the second user inputs the first token identification information UNQ_1 to the second user terminal 20_2 while the application installed in the second user terminal 20_2 is active, the first user may approve the transfer of the non-fungible token while the application installed in the first user terminal 20_1 is active to transfer the non-fungible token from the first blockchain wallet to the second blockchain wallet. The method of transferring the non-fungible token by the non-fungible token minting system 10 of FIG. 3E is exactly the same as the method of transferring the non-fungible token by the non-fungible token minting system 10 illustrated in the description of FIG. 3D, except that the first token identification information UNQ_1 is received through the second user terminal 20_2, and finally, approval of transfer of the non-fungible token is requested to the first user terminal 20_1. Therefore, description of the same operation as that of the non-fungible token minting system 10 shown in FIG. 3D is omitted below.

For reference, a method of inputting the first token identification information UNQ_1 to the second user terminal 20_2 may be the same as the method of inputting the first token identification information UNQ_1 to the first user terminal 20_1 described in FIG. 1A.

When the second user inputs the first token identification information UNQ_1 to the second user terminal 20_2 while the application installed in the second user terminal 20_2 is active, the second user terminal 20_2 may transfer the first token identification information UNQ_1 to the control server 230. Upon receiving the first token identification information UNQ_1, the control server 230 may determine whether a non-fungible token corresponding to the first token identification information UNQ_1 has already been minted. If the non-fungible token has already been minted, the control server 230 may check whether the blockchain wallet storing the non-fungible token corresponding to the first token identification information UNQ_1 is the second blockchain wallet. If the non-fungible token is not stored in the second blockchain wallet, the control server 230 may request approval (or digital signature) of a transaction to transfer the non-fungible token to the first user terminal 20_1 in which the non-fungible token is stored (REQ_APP). The control sever 230 may transfer the second wallet address information ADD_2 corresponding to the second blockchain wallet requesting the transfer of the non-fungible token together with the above request REQ_APP.

Alternatively, the second user may input the first token identification information UNQ_1 to the second user terminal 20_2, and in the case that the non-fungible token corresponding to the first token identification information UNQ_1 has already been minted and the non-fungible token is not stored in the second blockchain wallet, the second user may request transfer of the non-fungible token (REQ_TR). When the request REQ_TR is received from the second user terminal 20_2, the non-fungible token minting system 10 may transfer a request for approval of the transaction REQ_APP to the first user terminal 20_1. The control server 230 may transfer the second wallet address information ADD_2 corresponding to the second blockchain wallet requesting the transfer of the non-fungible token together with the request REQ_APP.

When the first user approves the transaction to transfer the non-fungible token corresponding to the first token identification information UNQ_1 from the first blockchain wallet to the second blockchain wallet through the first user terminal 20_1, the first user terminal 20_1 may transfer the first wallet address information ADD_1, the second wallet address information ADD_2, and the first token ID ID_1 to the blockchain network 30 to transfer the non-fungible token corresponding to the first token ID ID_1 stored in the first blockchain wallet from the first blockchain wallet to the second blockchain wallet.

As such, using the non-fungible token minting system 10 according to an embodiment of the present disclosure, the user may install the application on his or her user terminal (20_1 or 20_2) and register as a user of the application to mint, check, and transfer the non-fungible token. In other words, the user may easily mint, own, and transfer the non-fungible token through the non-fungible token minting system 10 without going through complex or legally restricted processes such as opening a bank account, registering with an exchange, and creating a personal blockchain wallet.

Using the non-fungible token minting system 10 according to an embodiment of the present disclosure, non-fungible tokens may be freely traded directly between users without using an existing coin or token trading website. In other words, the non-fungible token minting system 10 may also act as an exchange.

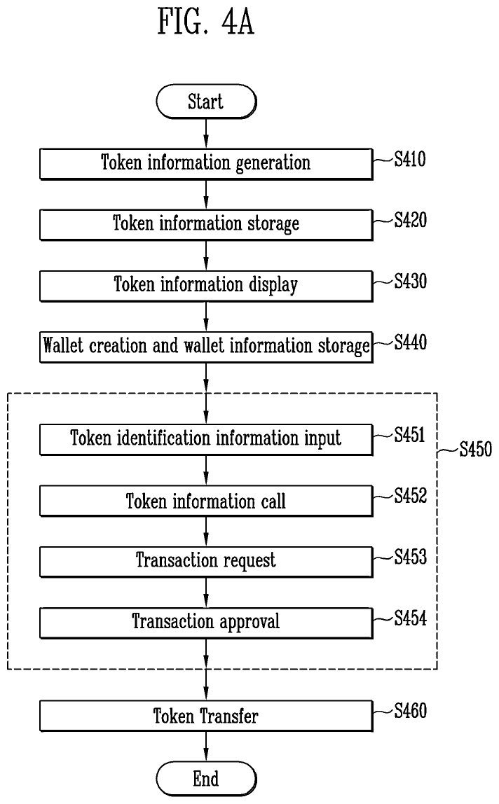

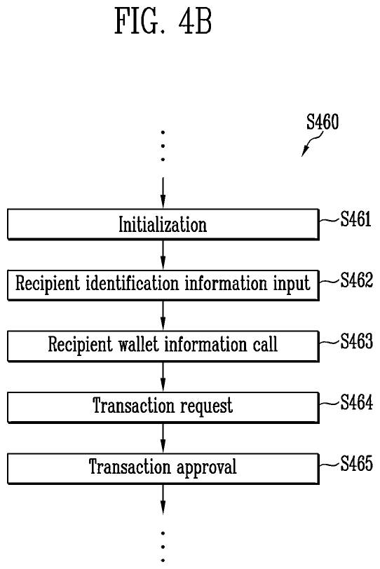

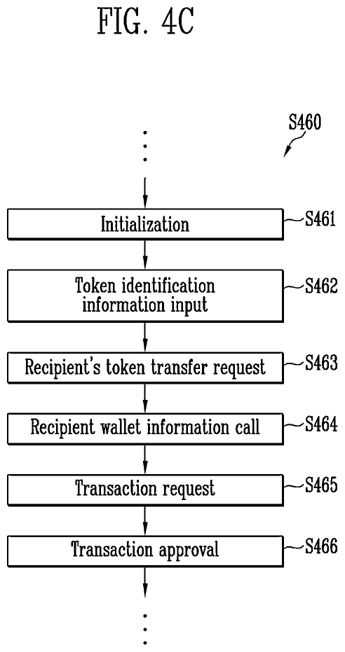

FIGS. 4A to 4C are flowcharts for illustrating a method of minting a non-fungible token according to an embodiment of the present disclosure.

FIG. 4A is a flowchart for illustrating the overall operation of the method of minting a non-fungible token according to an embodiment of the present disclosure, and FIGS. 4B and 4C are flowcharts for illustrating a token transfer step S460 of the non-fungible token minting method according to an embodiment of the present disclosure.

As shown in FIG. 4A, the non-fungible token minting method includes a token information generation step S410, a token information storage step S420, a token information display step S430, a wallet creation and wallet information storage step S440, a token minting step S450, and the token transfer step S460.

In the token information generation step S410, a plurality of non-fungible token information (NFT_1˜NFT_n) including one or more digital content information (CON_1˜CON_n), one or more token identification information (UNQ_1˜UNQ_n), one or more token address information (URL_1 to URL_n), and token IDs (ID_1˜ID_n) may be generated.

One or more digital content information CON_1˜CON_n may be information including one or more data of image data, sound source data, and video data. One or more digital content information CON_1˜CON_n is data stored and preserved in an external storage medium other than the blockchain network as the original digital content of the non-fungible token itself, and may be stored in the content information storage 210 of the non-fungible token minting system 10. The content information storage 210 may store one or more token identification information UNQ_1˜UNQ_n together with one or more digital content information CON_1˜CON_n.

The token information storage step S420 may include storing one or more non-fungible token information NFT_1˜NFT_n at an address corresponding to one or more token identification information UNQ_1˜UNQ_n of the token information storage 220. One or more non-fungible token information NFT_1˜NFT_n stored in the token information storage step S520 may be called using one or more token identification information UNQ_1˜UNQ_n.

In the token information display step S430, the token identification information UNQ_1˜UNQ_n included in the non-fungible token information NFT_1˜NFT_n may be visualized and displayed on a tangible object (e.g., a physical card). In the token information display step S430, a string of the token identification information (UNQ_1˜UNQ_n) may be displayed as it is, or may be converted into a form that can be recognized through a device (e.g., a camera) that recognizes visual information provided in a smart device such as a barcode or a QR code and displayed. In the token information display step S430, other information included in one or more non-fungible token information NFT_1˜NFT_n may be displayed on one or more tangible objects. In addition, in the token information display step S430, some or all of one or more digital content information (CON_1˜CON_n), one or more token identification information (UNQ_1˜UNQ_n), and one or more token IDs (ID_1˜ID_n) included in one or more non-fungible token information (NFT_1˜NFT_n) may be displayed. For example, in the token information display step S430, when one or more digital content information CON_1˜CON_n is an image, the image may be displayed on the tangible object, and one or more token identification information UNQ_1˜UNQ_n may be transformed into a barcode or QR code to be displayed on the tangible object.

In the wallet creation and wallet information storage step S440, when the user installs the application necessary for minting, checking, and transferring a non-fungible token in the first user terminal 20_1 and registers the first user identification information USER_1, the first blockchain wallet may be created, and the first wallet address information ADD_1 indicating the address of the first blockchain wallet and the first approval information APP_1 used to approve the transaction of the first blockchain wallet may be matched with the first user identification information USER_1 and stored. The first wallet address information ADD_1 and the first approval information APP_1 may be stored in the wallet information storage 240. The first wallet address information ADD_1 and the first approval information APP_1 may be stored on the same server or storage, or may be stored in different servers or storages, and the server or storage in which the first wallet address information ADD_1 and the first approval information APP_1 are stored may be a server or storage included in the non-fungible token minting system 10, or the server may be a server that is not included in the non-fungible token minting system 10 and exists outside.

In the token minting step S450, the first token identification information UNQ_1 may be input through the first user terminal, and the non-fungible token corresponding to the first non-fungible token information NFT_1 may be minted to the first blockchain wallet having the first wallet address information ADD_1 matched with the first user identification information USER_1 on the blockchain network 30 using the first non-fungible token information NFT_1 stored at the address corresponding to the first token identification information UNQ_1 of the token information storage 220.

The token minting step S450 may include a token identification information input step S451, a token information call step S452, a transaction request step S453, and a transaction approval step S454.

The token identification information input step S451 may be a step of receiving the first token identification information UNQ_1 through the first user terminal 20_1 while the application installed in the first user terminal 20_1 is active. A method of inputting the first token identification information UNQ_1 through the first user terminal 20_1 may include a method of directly inputting it using an input device (e.g., a keypad) of the first user terminal 20_1 or a method of recognizing and inputting a barcode or QR code displayed on the tangible object (e.g., a physical card, etc.) through a recognition device (e.g., a camera) provided in the first user terminal 20_1.

In the token information call step S452, the control server 230 may receive the first token identification information UNQ_1 and transfer it to the token information storage 220, and in response to the first token identification information UNQ_1, the token information storage 220 may transfer the first non-fungible token information NFT_1 stored in the address corresponding to the first token identification information UNQ_1 to the control server 230.

In the transaction request step S453, the control server 230 may transfer the first token ID ID_1 included in the first non-fungible token information NFT_1 and the first user identification information USER_1 to the wallet information storage 240, and, when, in response to this, the wallet information storage 240 sends the first wallet address information (ADD_1) matched with the first user identification information USER_1 and stored to the control server 230, the first token ID ID_1 and the first user identification information USER_1 may be requested to be transferred to the contract address of the non-fungible token.

In the transaction approval step S454, the control server 230 may transfer the first user identification information USER_1 to the wallet information storage 240, and when, in response to this, the wallet information storage 240 sends the first approval information APP_1 matched with the first user identification information USER_1 and stored to the control server 230, the above request may be approved.

The fee (or gas fee) should be transferred in order to execute the transaction to mint the non-fungible token, and the non-fungible token minting method according to an embodiment of the present disclosure may include, so that the user's blockchain wallet does not have to directly transfer the fee, (i) transferring the fungible token used as the fee required to execute the transaction to mint the non-fungible token from a wallet other than the first blockchain wallet minting the non-fungible token (e.g., the blockchain wallet of the administrator of the non-fungible token minting system) in the token minting step S450, (ii) transferring the fungible token to the first blockchain wallet prior to executing the transaction to mint the non-fungible token in the token minting step S450, or (iii) checking an amount of fungible tokens held in the first blockchain wallet so that the amount of fungible tokens held in the first blockchain wallet is maintained at a predetermined value and, when the amount of the fungible tokens is lower than the predetermined value, transferring the fungible token to the first blockchain wallet, by the non-fungible token minting system 10. Preferably, in the case of (i), the non-fungible token minting method may execute the transaction to mint the non-fungible token to the first blockchain wallet in a wallet other than the first blockchain wallet (e.g., the blockchain wallet of the administrator of the non-fungible token minting system).

As shown in FIG. 4B, the token transfer step S460 of the non-fungible token minting method according to an embodiment of the present disclosure may include an initialization step S461, a recipient identification information input step S462, a recipient wallet information call step S463, a transaction request step S464, and a transaction approval step S465.

In addition, by installing the application in the second user terminal 20_1 and inputting the second user identification information USER_2 while the application is active, the second user may register himself or herself as a user USER of the application. When the second user registers himself or herself as the user, the non-fungible token minting system 10 may create the second blockchain wallet, and match the second wallet address information ADD_2 and the second approval information APP_2 to the second user identification information USER_2 to store them. As such, the steps for the second user to register himself or herself as the user of the application or the non-fungible token minting system 10, of creating the second blockchain wallet, and of storing the second wallet address information ADD_2 and the second approval information APP_2 are exactly the same as the wallet creation and wallet information storage step S440, and may be performed at any time prior to the token transfer step S460. Therefore, in the token transfer step S460, the second blockchain wallet of the second user to receive the non-fungible token may have already been created.

The initialization step S461 may be a step of transferring information required to use the application in advance from the non-fungible token minting system 10 to the first user terminal 20_1 by the first user activating the application in the first user terminal 20_1 and inputting the first user identification information USER_1 already registered in the first user terminal 20_1. In the initialization step S461, when the first user identification information (USER_1) input into the first user terminal 20_1 after the first user activates the application is transferred to the control server 230, the control server 230 may transfer the first wallet address information ADD_1 stored to be matched to the first user identification information USER_1 and the first non-fungible token information NFT_1 corresponding to the non-fungible token stored in the first blockchain wallet in the control server 230 from the wallet information storage 240 to the first user terminal 20_1 and the first user terminal 201 may store information received from the control server 230.

The recipient identification information input step S462 may be a step of activating the application in the first user terminal 20_1 and inputting the second user identification information USER_2. The first user terminal 20_1 may transfer the input second user identification information USER_2 to the control server 230.

In the recipient wallet information call step S463, the control server 230 receiving the second user identification information USER_2 from the first user terminal 20_1 may transfer the second user identification information USER_2 to the wallet information storage 240, the wallet information storage 240 receiving the second user identification information USER_2 may transfer the second wallet address information ADD_2 stored to be matched to the second user identification information USER_2 to the control server 230, and the control server 230 may transfer the second wallet address information ADD_2 received from the wallet information storage 240 to the first user terminal 20_1.

The transaction request step S464 is a step of requesting the first wallet address information ADD_1 transferred to the first user terminal 20_1 in the initialization step S461, the first token ID ID_1, and the second wallet address information ADD_2 received in the recipient wallet information call step S463 to be transferred to the contract address of the non-fungible token.

In the transaction approval step S465, when the first user terminal 20_1 transfers the first user identification information USER_1 input by the first user after activating the application to the control server 230, the control server 230 may retrieve the first approval information APP_1 stored to be matched to the first user identification information USER_1 from the wallet information storage 240 and transfer it to the first user terminal 20_1, and the first user terminal 20_1 may use the first authorization information APP_1 to approve (or electronically sign) the above request. Here, the first approval information APP_1 may be transferred from the control server 230 to the first user terminal 20_1 in the transaction approval step S465, but may be transferred from the control server 230 to the first user terminal 20_1 in the initialization step S461. In the latter case, in the transaction approval step S465, the control server 230 may use the first approval information APP_1 already transferred in the initialization step S461 to approve the request without transferring the first approval information APP_1 to the first user terminal 20_1.

The fee (or gas fee) should be transferred in order to execute the transaction to transfer the non-fungible token, and the non-fungible token minting method according to an embodiment of the present disclosure includes (i) transferring the fungible token to the first blockchain wallet prior to executing the transaction to mint the non-fungible token in the token transfer step S460, or (ii) checking an amount of fungible tokens held in the first blockchain wallet so that the amount of fungible tokens held in the first blockchain wallet is maintained at a predetermined value and, when the amount of the fungible tokens is lower than the predetermined value, transferring the fungible token to the first blockchain wallet, so that the user's blockchain wallet does not have to directly transfer the fee.

As shown in FIG. 4C, the token transfer step S460 of the non-fungible token minting method according to another embodiment of the present disclosure includes an initialization step S461, a token identification information input step S462, a recipient's token transfer request step S463, a recipient wallet information call step S464, a transaction request step S465, and a transaction approval step S466.

The description of the initialization step S461 is the same as described in FIG. 4B.

The token identification information input step S462 may be a step of receiving the first token identification information UNQ_1 through the second user terminal 20_2 while the application installed in the second user terminal 20_2 is active. A method of inputting the first token identification information UNQ_1 using the second user terminal 20_2 in the token identification information input step S462 may be the same as described above.

The recipient's token transfer request step S463 may be a step of (i) requesting (REQ_TR) transfer of the non-fungible token directly to the control server 230 through the second user terminal 20_2 by the second user, or (ii) requesting transfer of the non-fungible token by transferring the first token identification information UNQ_1 input to the second user terminal 20_2 to the control server 230. A process of (i) requesting (REQ_TR) the transfer of the non-fungible token directly to the control server 230 through the second user terminal 20_2 by the second user, or (ii) requesting the transfer of the non-fungible token by transferring the first token identification information UNQ_1 input to the second user terminal 20_2 to the control server 230 in the recipient's token transfer request step S463 is the same as those described in FIGS. 1E and 3E, so it is omitted.

The recipient wallet information call step S464 may be a step of retrieving the second wallet address information ADD_2 to transfer the non-fungible token from the first user terminal S464. The first user terminal S464 may receive the second wallet address information ADD_2 together with a request (REQ_APP) for approval of the transfer of the non-fungible token from the control server 230. The control server 230 may transfer the second wallet address information ADD_2 corresponding to the second blockchain wallet requesting the transfer of the non-fungible token together with the above request REQ_APP.

The transaction request step S465 and the transaction approval step S466 may be the same as the transaction request step S464 and the transaction approval step S465 described above with regard to FIG. 4B.

As such, using the non-fungible token minting method according to an embodiment of the present disclosure, the user may install the application on his or her user terminal (20_1, 20_2) and register as a user of the application to mint, check, and transfer the non-fungible token. In other words, the user may easily mint, own, and transfer the non-fungible token through the non-fungible token minting method without going through complex or legally restricted processes such as opening a bank account, registering with an exchange, and creating a personal blockchain wallet.

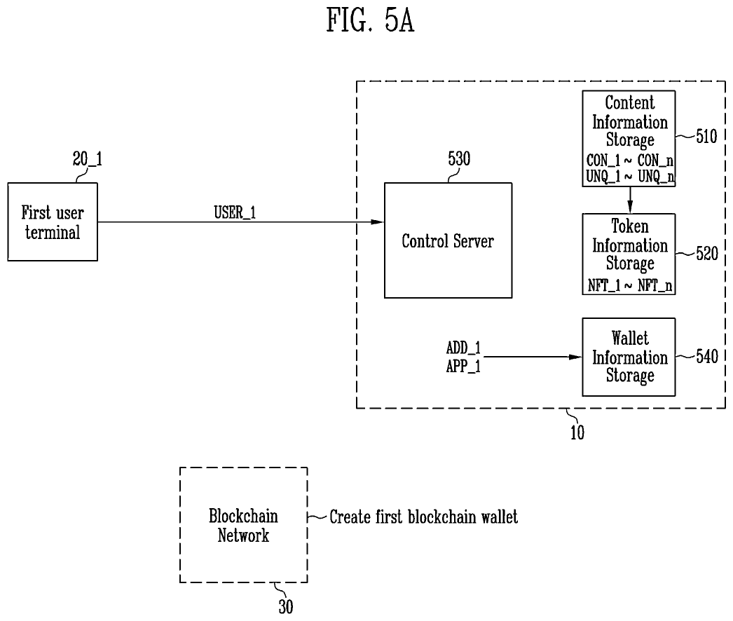

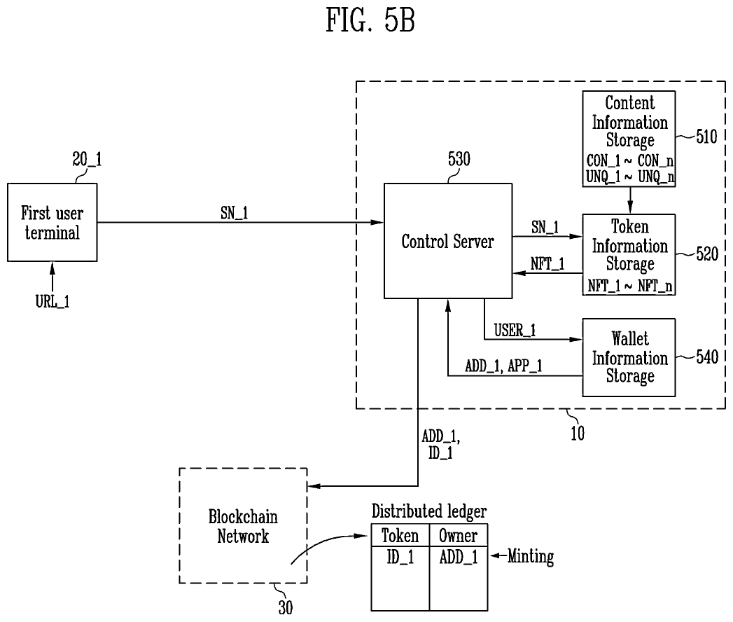

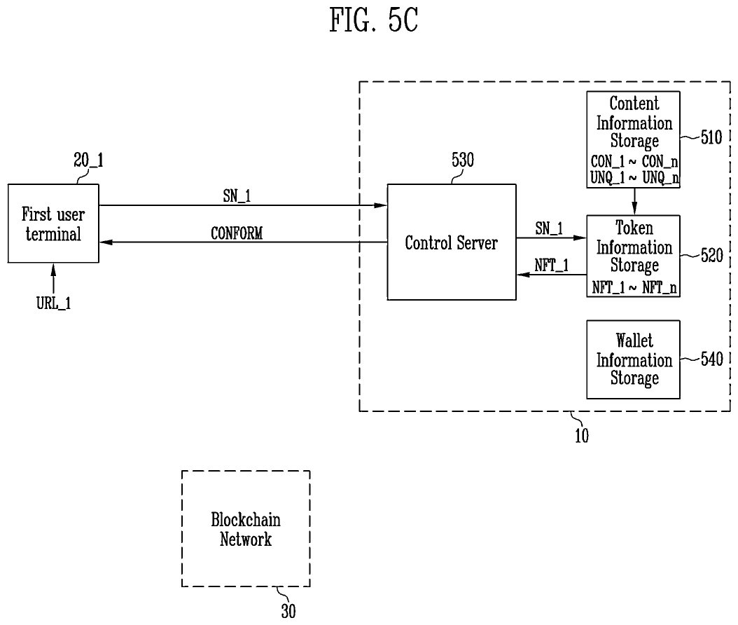

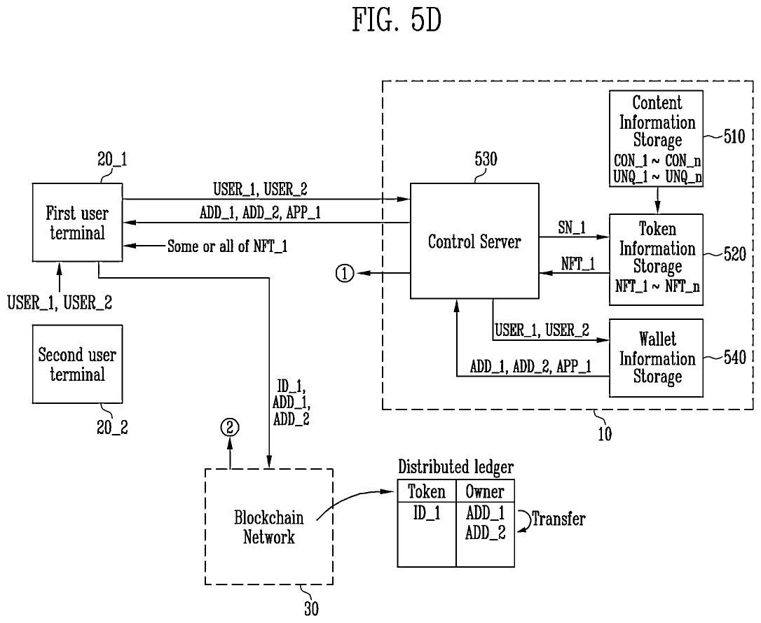

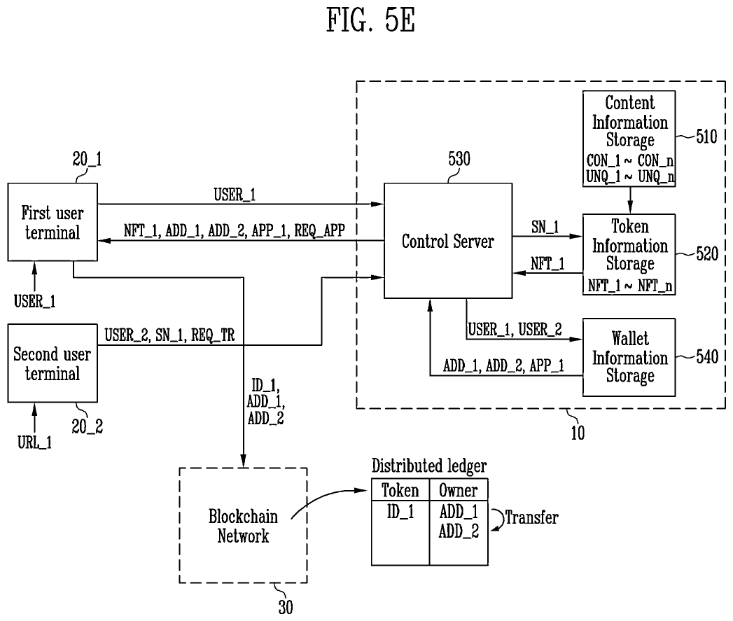

FIGS. 5A to 5E are drawings for illustrating operations of the non-fungible token minting system 10 according to another embodiment of the present disclosure.

The non-fungible token minting system 10 according to another embodiment of the present disclosure is very similar to the non-fungible token minting system 10 according to one embodiment of the present disclosure described in FIGS. 2 to 3E except that (i) URL (Uniform Resource Locator) information URL_1 indicating the address at which the non-fungible token NFT_1 is stored is input instead of the token identification information corresponding to the address at which the non-fungible token information NFT_1 is stored, (ii) the token identification information is a serial number SN_1 of the token, and (iii) the URL information URL_1 includes an address for downloading the application and the serial number of the token.

The non-fungible token minting system 10 shown in FIGS. 5A to 5E may include a content information storage 510, a token information storage 520, a control server 530, and a wallet information storage 540. The content information storage 510, the token information storage 520, the control server 1530, and the wallet information storage 540 shown in FIGS. 5A to 5E may be similar in function to the content information storage 210, the token information storage 220, the control server 230, and the wallet information storage 240 shown in FIGS. 2 and 3A to 3E.

FIG. 5A is a diagram for illustrating a process of generating the first blockchain wallet through the non-fungible token minting system 10 according to an embodiment of the present disclosure by the first user using the first user terminal 20_1.

As shown in FIG. 5A, the first user may install the application necessary for minting, checking, and transferring a non-fungible token using the non-fungible token minting system 10 in the first user terminal 20_1.

When the first user inputs the first URL information URL_1 to the first user terminal 20_1 without activating the application in the first user terminal 20_1, the first user terminal 20_1 may be connected to a web page from which the application can be downloaded. The first user may download and install the application from the above web page to the first user terminal 20_1. When the first user inputs the first URL information URL_1 to the first user terminal 20_1 while the application is activated in the first user terminal 20_1, the first user terminal 201 may transfer only the first token serial number SN_1 of the first URL information URL_1 to the control server 530.

Thereafter, a process of generating the wallet by the non-fungible token minting system 10 may be the same as the process of creating the wallet by the non-fungible token minting system 10 of FIGS. 2 and 3A except that the first token identification information UNQ_1 is the first token serial number SN_1.

When the user installs the application in the user terminal and registers himself or herself as the user of the application and inputs only the user identification information to distinguish himself or herself from other users, the non-fungible token minting system 10 automatically creates the blockchain wallet corresponding to the user identification information and manages the wallet address information and approval information of the blockchain wallet. Therefore, the user may mint, own, and trade the non-fungible token without creating his or her own blockchain wallet or managing the wallet address information and approval information of the blockchain wallet.

FIG. 5B is a diagram for illustrating a process of minting a non-fungible token to the first blockchain wallet through the non-fungible token minting system 10 according to an embodiment of the present disclosure using the first user terminal 20_1.

As shown in FIG. 5B, the first user may input the first URL information URL_1 corresponding to the address at which the first non-fungible token is stored through the first user terminal 20_1 while the application installed in the first user terminal 20_1 is active. When the first user inputs the first URL information URL_1 to the first user terminal 20_1 while the application is activated in the first user terminal 20_1, the first user terminal 20_1 may transfer only the first token serial number SN_1 of the first URL information URL_1 to the control server 530.

Thereafter, a process of creating the wallet by the non-fungible token minting system 10 may be the same as the process of minting the non-fungible token by the non-fungible token minting system 10 of FIGS. 2 and 3B except that the first token identification information UNQ_1 is the first token serial number SN_1.

FIG. 5C is a diagram for illustrating a process of checking a non-fungible token in possession of the first blockchain wallet corresponding to the first user terminal 20_1 in the non-fungible token minting system 10 according to an embodiment of the present disclosure.

When token identification information corresponding to a non-fungible token that has already been minted is input, the control server 530 cannot re-mint the non-fungible token. Therefore, the user terminal inputting the token identification information may confirm that the non-fungible token has already been minted.

As shown in FIG. 5C, the first user may input the first URL information UNQ_1 indicating the address at which the first non-fungible token is stored through the first user terminal 20_1 while the application installed in the first user terminal 20_1 is active.

When the first user inputs the first URL information URL_1 to the first user terminal 20_1 while the application is activated in the first user terminal 20_1, the first user terminal 20_1 may transfer only the first token serial number SN_1 of the first URL information URL_1 to the control server 530.

Thereafter, a process of checking that the non-fungible token corresponding to the first token serial number SN_1 has been minted to the first blockchain wallet by the non-fungible token minting system 10 may be the same as the process of minting the non-fungible token by the non-fungible token minting system 10 of FIGS. 2 and 3C except that the first token identification information UNQ_1 is the first token serial number SN_1.

FIGS. 5D and 5E are drawings for illustrating a ‘transfer’ operation of a non-fungible token of the non-fungible token minting system 10 according to an embodiment of the present disclosure.

The person to whom the non-fungible token is transferred, in other words, the user of the second user terminal 20_2, may be a user who installs the application in the second user terminal 202, registers the second user identification information USER_2, and creates the second blockchain wallet. A process of creating the second blockchain wallet and a process of matching and storing the second wallet address information ADD_2 of the second blockchain wallet and the second approval information APP_2 to the second user identification information USER_2 are the same as those described with respect to FIG. 5A and are omitted.

In addition, the ‘transfer’ of the non-fungible token assumes that the non-fungible token has been ‘minted’, and the ‘minting’ operation of the non-fungible token performed prior to the ‘transfer’ of the non-fungible token is the same as the ‘minting’ operation of the non-fungible token described with respect to FIG. 5B and thus is omitted.

The non-fungible token minting system 10 according to an embodiment of the present disclosure may transfer the non-fungible token stored in the first blockchain wallet from the first blockchain wallet to the second blockchain wallet by: (i) by receiving the first user identification information USER_1 while the application is activated in the first user terminal 20_1, and then inputting the second user identification information USER_2 of the person to whom the non-fungible token is to be transferred (the user using the second user terminal 20_2, the owner of the second blockchain wallet) to the first user terminal 20_1 and approving transfer of the non-fungible token at the first user terminal (see FIG. 5D and its description below); or (ii) by receiving the first URL information URL_1 while activating the application in the second user terminal 20_2, and then approving the transfer of the non-fungible token at the first user terminal 201 (see FIG. 5E and its description below).

A process of transferring the non-fungible token by the non-fungible token minting system 10 of FIG. 5D may be the same as the process of transferring the non-fungible token by the non-fungible token by the non-fungible token minting system 10 of FIGS. 2 and 3D except that the first token identification information UNQ_1 is the first token serial number SN_1.

As shown in FIG. 5E, after the second user inputs the first URL information URL_1 to the second user terminal 20_2 while the application installed in the second user terminal 20_2 is active, the first user may approve the transfer of the non-fungible token while the application installed in the first user terminal 20_1 is active to transfer the non-fungible token from the first blockchain wallet to the second blockchain wallet. A process of transferring the non-fungible token by the non-fungible token minting system of FIG. 5E may be the same as the process of transferring the non-fungible token by the non-fungible token minting system 10 of FIGS. 2 and 3E except that the first URL information URL_1 is received through the second user terminal 20_2 and only the first token serial number SN_1 of the first URL information (URL_1) is transferred to the control server 530.

As such, using the non-fungible token minting system 10 according to an embodiment of the present disclosure, the user may install the application on his or her user terminal (20_1, 20_2) and register as a user of the application to mint, check, and transfer the non-fungible token. In other words, the user may easily mint, own, and transfer the non-fungible token through the non-fungible token minting system 10 without going through complex or legally restricted processes such as opening a bank account, registering with an exchange, and creating a personal blockchain wallet.

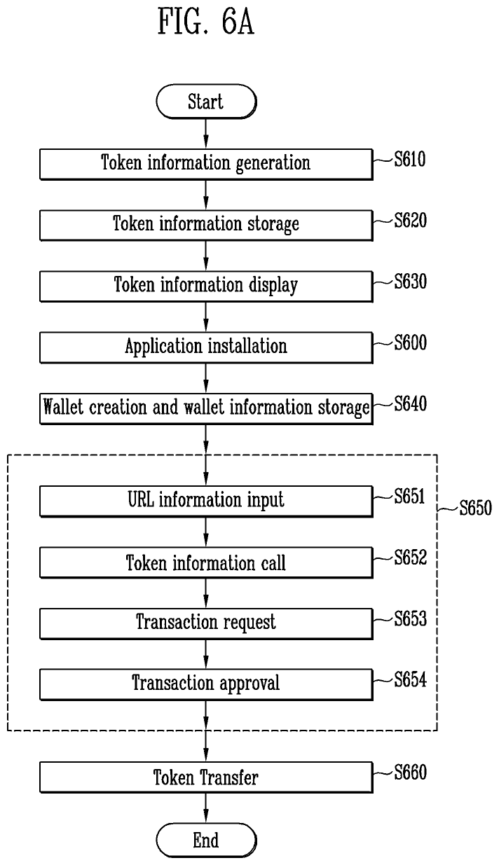

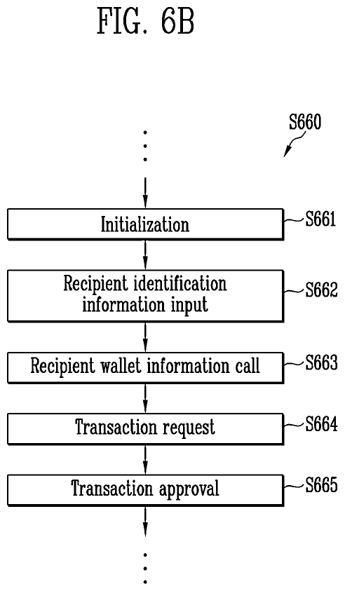

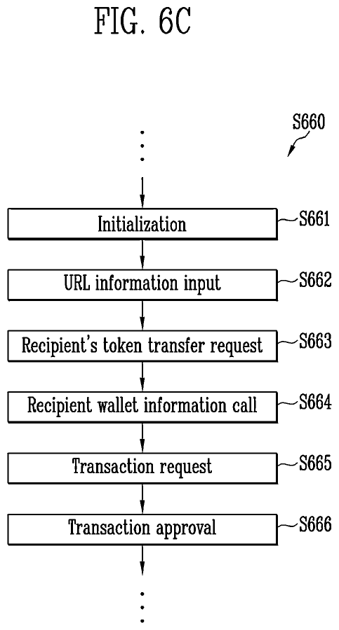

FIGS. 6A to 6C are flowcharts for illustrating a non-fungible token minting method according to another embodiment of the present disclosure. The non-fungible token minting method described in FIGS. 6A to 6C is a non-fungible token minting method using the non-fungible token minting system described in FIGS. 5A to 5E and is very similar to the non-fungible token minting system 10 according to one embodiment of the present disclosure described in FIGS. 4A to 4E except that (i) URL (Uniform Resource Locator) information URL_1 indicating the address at which the non-fungible token NFT_1 is stored is input instead of the token identification information corresponding to the address at which the non-fungible token information NFT_1 is stored, (ii) the token identification information is the serial number SN_1 of the token, and (iii) the URL information URL_1 includes the address for downloading the application and the serial number of the token.

FIG. 6A is a flowchart for illustrating the overall operation of the non-fungible token minting method according to an embodiment of the present disclosure, and FIGS. 6B and 6C are flowcharts for illustrating a token transfer step S660 of the non-fungible token minting method according to an embodiment of the present disclosure.

As shown in FIG. 6A, the non-fungible token minting method may include a token information generation step S610, a token information storage step S620, a token information display step 630, a wallet creation and wallet information storage step S640, a token minting step S650, and a token transfer step S660. The non-fungible token minting method may further include an application installation step S600.

In the token information generation step S610, a plurality of non-fungible token information (NFT_1˜NFT_n) including one or more digital content information (CON_1˜CON_n), one or more URL information (URL_1˜URL_n), and token IDs (ID_1˜ID_n) may be generated.

The token information storage step S620 may be a step of storing one or more non-fungible token information NFT_1˜NFT_n at addresses corresponding to one or more URL information URL_1˜URL_n of the token information storage 220. One or more non-fungible token information NFT_1˜NFT_n stored in the token information storage step S620 may be called using one or more token identification information UNQ_1˜UNQ_n.

In the token information display step S630, the URL information URL_1˜URL_n included in the non-fungible token information NFT_1˜NFT_n may be visualized and displayed on the tangible object (e.g., a physical card). In the token information display step S630, a string of the URL information (URL_1˜URL_n) may be displayed as it is, or may be converted into a form that can be recognized through a device (e.g., a camera) that recognizes visual information provided in a smart device such as a barcode or a QR code and displayed. In the token information display step S630, other information included in one or more non-fungible token information NFT_1˜NFT_n may be displayed on one or more tangible objects. In addition, in the token information display step S630, some or all of one or more digital content information (CON_1˜CON_n), one or more URL information (URL_1˜URL_n), and one or more token IDs (ID_1˜ID_n) included in one or more non-fungible token information (NFT_1˜NFT_n) may be displayed. For example, in the token information display step S630, when one or more digital content information CON_1˜CON_n is an image, the image may be displayed on the tangible object, and one or more URL information URL_1˜URL_n may be transformed into a barcode or QR code to be displayed on the tangible object.

The application installation step S600 may be a step of installing the application necessary for the first user to mint, check, and transfer the non-fungible token using the non-fungible token minting system 10 in the first user terminal 20_1. When the first user inputs the first URL information URL_1 to the first user terminal 20_1 without activating the application in the first user terminal 20_1, the first user terminal 20_1 may be connected to a web page from which the application can be downloaded. The first user may download and install the application from the above web page to the first user terminal 20_1. When the first user inputs the first URL information URL_1 to the first user terminal 20_1 while the application is activated in the first user terminal 20_1, the first user terminal 20_1 may transfer only the first token serial number SN_1 of the first URL information URL_1 to the control server 230.

The wallet creation and wallet information storage step S640 may be the same as the wallet creation and wallet information storage step S440 of FIG. 4A.

The token minting step S650 may include a URL information input step S651, a token information call step S652, a transaction request step S653, and a transaction approval step S654.

The URL information input step S651 may be a step of receiving the first URL information URL_1 through the first user terminal 20_1 while the application installed in the first user terminal 20_1 is active. A method for the user to input the first token identification information UNQ_1 through the first user terminal 20_1 may include a method of directly inputting it using an input device (e.g., a keypad) of the first user terminal 20_1 or a method of recognizing and inputting a barcode or QR code displayed on the tangible object (e.g., a physical card, etc.) through a recognition device (e.g., a camera) provided in the first user terminal 20_1.

In the token information call step S652, the control server 230 may receive the first token serial number SN_1 included in the first URL information URL_1 and transfer it to the token information storage 220, and in response to the first token serial number SN_1, the token information storage 220 may transfer the first non-fungible token information NFT_1 stored in the address corresponding to the first token serial number SN_1 to the control server 230.

The transaction request step S653 and the transaction approval step S654 may be the same as the transaction request step S453 and the transaction approval step S454 of FIG. 4A.

The token minting step S650 may be the same as the token minting step S450 of FIG. 4A except that the first URL information URL_1 is received through the first user terminal 20_1 instead of the first token identification information UNQ_1 and the first user terminal 20_1 may transfer only the first token serial number SN_1 of the first URL information URL_1 having the same function as the first token identification information UNQ_1 to the non-fungible token minting system 10.

As shown in FIG. 6B, the token transfer step S660 of the non-fungible token minting method according to another embodiment of the present disclosure may include an initialization step S661, a recipient identification information input step S662, a recipient wallet information call step S663, a transaction request step S664, and a transaction approval step S665.

As shown in FIG. 6C, the token transfer step S660 of the non-fungible token minting method according to another embodiment of the present disclosure may include an initialization step S661, an URL information as a token identification information input step S662, a recipient's token transfer request step S663, a recipient wallet information call step S664, a transaction request step S665, and a transaction approval step S666.

The token transfer steps S660 of FIGS. 6B and 6C may be the same as the token transfer steps S460 of FIGS. 4B and 4C except that the first and second user terminals (20_1 and 20_2) receive the first URL information URL_1 including the first token serial number SN_1 having the same function as the first token identification information UNQ_1 instead of the first token identification information UNQ_1 and transfer only the first token serial number SN_1 of the first URL information URL_1 to the control server 230.

As such, using the non-fungible token minting method according to an embodiment of the present disclosure, the user may install the application in his or her user terminal (20_1, 20_2) and register himself or herself as a user of the application to mint, check, and transfer the non-fungible token. In other words, the user may easily mint, own, and transfer the non-fungible token through the non-fungible token minting method without going through complex or legally restricted processes such as opening a bank account, registering with an exchange, and creating a personal blockchain wallet.

For reference, although the case where the first user uses the first user terminal 20_1 and the second user uses the second user terminal 20_2 to utilize the non-fungible token minting system 10 or the minting method has been described, each of the first and second users may register himself or herself as a user of the non-fungible token minting system 10 or the minting method using each of the first and second user identification information (USER_1 and USER_2), and then install the application in other user terminals other than the first and second user terminals 20_1 and 20_2, and input his or her user identification information (USER_1, USER_2) in the state where the application is activated to use the non-fungible token minting system 10 or the minting method in the same way as in the case of using each of the first and second user terminals 20_1 and 20_2. Alternatively, each of the first and second user terminals 20_1 and 20_2 is not a user terminal owned or stored by each of the first or second user, but a user terminal ready to use the non-fungible token minting system 10 or the minting method in which a user installs the application and to which the user inputs his or her user identification information (USER_1, USER_2) while the application is active.

FIGS. 7A and 7B are diagrams illustrating the front (FIG. 7A) and the back (FIG. 7B) of a tangible object (physical card) used in a non-fungible token minting method and a non-fungible token minting system according to an embodiment of the present disclosure.

FIGS. 7A and 7B illustrate a case in which the non-fungible token managed by the non-fungible token minting method and system according to an embodiment of the present disclosure is a non-fungible token associated with the idol group.

As shown in FIG. 7A, the name of the idol group 701, a photo of the idol group member 702, and name of the idol group member 703 displayed in the photo may be displayed on the front of the tangible object (physical card). Information displayed on the front of the tangible (physical card) may be information included in the digital content information of the non-fungible token.

As shown in FIG. 7B, on the back of the tangible object (physical card), a mark of the idol group 704, the name of the idol group member 705, the class of the non-fungible token 706 arbitrarily determined, the minting season 1707, signature of the idol group member 708, and URL information URL_1 in the form of a QR code 709 of the information included in the non-fungible token information NFT_1 may be displayed. The URL information may include an Internet address for downloading an application that should be installed on the user terminal to use the non-fungible token minting system and a token serial number of the non-fungible token.

In FIGS. 7A and 7B, information corresponding to the digital content information among the information included in the non-fungible token information is displayed on the front and back of the tangible object (physical card), and the token address information URL_1 converted into the QR code is displayed on the back of the tangible object (physical card). However, information displayed on the front and back of the tangible object (real card) may be selected in various ways.

When the user recognizes the QR code 709 displayed on the back of the tangible object (physical card) of FIG. 7A with a camera activated on a smartphone, the non-fungible token minting system may mint a non-fungible token that corresponds 1:1 to the tangible object (a physical card) on the blockchain network. In addition, the user may input another user's nickname while the application is activated in the smart phone or a user other than the user who mints and owns the non-fungible token may recognize the QR code 709 displayed on the back (BACK) of the tangible object (physical card) with the camera while the application is activated in his or her smartphone and the user who mints and owns the above non-fungible token approves the transfer on his or her smartphone, to transfer the non-fungible token corresponding 1:1 to the tangible object (physical cards) from one user's blockchain wallet to another user's blockchain wallet.

Operations of the method according to an embodiment of the present disclosure may be implemented as a computer-readable program or code on a non-transitory computer-readable recording medium. A computer-readable recording medium includes any kind of recording device in which data that can be read by a computer system is stored. In addition, computer-readable recording media can be distributed in networked computer systems so that computer-readable programs or codes can be stored and executed in a distributed manner.

In addition, the computer-readable recording medium may include a hardware device specially configured to store and execute program instructions, such as a ROM, RAM, and flash memory. Program instructions may include machine code such as those created by compilers, as well as high-level language code that can be executed by a computer using an interpreter, for example.

Some aspects of the present disclosure have been described in the context of a device, but may also indicate descriptions according to the corresponding method, wherein a block or device corresponds to a method step or a feature of the method step. Similarly, aspects described in the context of a method may also be represented by features of a corresponding block or item or corresponding device. Some or all of the method steps may be performed by (or using) a hardware device such as, for example, a microprocessor, a programmable computer, or an electronic circuit. In some embodiments, one or more of the most important method steps may be performed by such a device.

In embodiments, a programmable logic device (e.g., a field programmable gate array) may be used to perform some or all of the functions of the methods described herein. In embodiments, the field programmable gate array may operate with a microprocessor for performing one of the methods described herein. In general, the methods are preferably performed by some hardware device.

Although the present invention has been described above with reference to preferred embodiments, those skilled in the art may understand that the present invention may be modified and changed in various ways within the spirit and scope of the appended claims.

Computer-readable recording media can be distributed across networked computer systems so that computer-readable code can be stored and executed in a distributed manner. In addition, functional programs, codes, and code segments for implementing the method may be easily deduced by programmers in the art to which the present invention pertains.

In addition, although preferred embodiments of the present invention have been shown and described above, the present invention is not limited to the specific embodiments described above, and various modifications and implementations are possible by those skilled in the art to which the present invention pertains without departing from the gist of the present invention claimed in the claims. These modified implementations should not be individually understood from the technical spirit or perspective of the present invention.

In the foregoing, even though all components constituting an embodiment of the present disclosure are described as being combined or operating together as one, the present disclosure is not necessarily limited to these embodiment. In other words, within the scope of the objects of the present disclosure, all the components may selectively combine and operate in one or more ways.

Although the operations are shown in a particular order in the drawing, it should not be understood that the operations should be executed in the particular order shown or sequentially or all the shown operations should be executed to obtain a desired result. In certain situations, multitasking and parallel processing may be beneficial. Moreover, in the embodiments described above, separation of the various components should not be understood as requiring such separation, but it should be understood that the described program components and systems may generally be integrated together into a single software product or packaged into multiple software products.

According to an embodiment, methods according to various embodiments disclosed herein may be included in a computer program product and provided. Computer program products may be traded between a seller and a buyer as a commodity. A computer program product may be distributed in the form of a storage medium (e.g., compact disc read only memory (CD-ROM)) that can be read by a device, or may be distributed (e.g., downloaded or uploaded) directly or online through an application store (e.g., Play Store™) or between two user devices (e.g., smartphones). In the case of online distribution, at least a portion of the computer program product may be temporarily stored or temporarily created on a storage medium that can be read by a device, such as a manufacturer's server, an application store's server, or a relay server's memory.

### EXPLANATION OF REFERENCE NUMERALS

210: Content Information Storage
220: Token Information Storage
230: Control Server
240: Wallet Information Storage

What is claimed is:

1. A non-fungible token (NFT) minting method of minting an NFT to a blockchain network, the NFT minting method comprising:
generating non-fungible token information, including digital content information, a token identification number, and a token ID;
storing the non-fungible token information at an address corresponding to token identification information;
receiving user identification information through a user terminal to create a blockchain wallet corresponding to the user identification information;
matching and storing wallet address information of the blockchain wallet with the user identification information; and
receiving the token identification information through the user terminal and minting the non-fungible token to the blockchain wallet having the wallet address information matched with the user identification information using the non-fungible token information stored at the address corresponding to the token identification information.

2. The NFT minting method of claim 1, further comprising visualizing the token identification information to display it on a tangible object.

3. The NFT minting method of claim 2, wherein the visualizing of the token identification information to display it on the tangible object comprises converting the token identification information into a barcode or QR code to display it on the tangible object.

4. The NFT minting method of claim 1, wherein the minting of the non-fungible token comprises allowing a token used as a fee required to execute a transaction to mint the non-fungible token to be transferred from a blockchain wallet other than the blockchain wallet to which the non-fungible token is minted.

5. The NFT minting method of claim 1, wherein the minting of the non-fungible token comprises transferring a token used as a fee required to execute a transaction to mint the non-fungible token to the blockchain wallet to which the non-fungible token is minted prior to executing the transaction to mint the non-fungible token.

6. The NFT minting method of claim 1, further comprising checking an amount of tokens used as a fee required to execute a transaction to mint the non-fungible token held in the blockchain wallet and, when the amount of the tokens is lower than a predetermined value, transferring the token used as the fee to the blockchain wallet.

7. The NFT minting method of claim 1, further comprising matching and storing approval information for approving a transaction to mint the non-fungible token to the blockchain wallet with the user identification information.

8. The NFT minting method of claim 7, wherein the minting of the non-fungible token comprises:
receiving the token identification information through the user terminal as input;
when the token identification information is input through the user terminal, retrieving the non-fungible token information from the address corresponding to the token identification information;
requesting the token ID included in the non-fungible token information and the wallet address information matched with the user identification information to be transferred to a contract address of the non-fungible token; and
retrieving the approval information matched with the user identification information to approve the request.

9. The NFT minting method of claim 1, wherein the digital content information comprises one or more of image data, sound source data, and video data.

10. The NFT minting method of claim 1, wherein the user identification information comprises one or more of an e-mail address of the user and a unique name of the user input by the user.

11. A non-fungible token (NFT) minting method of minting an NFT to a blockchain network using an application, the NFT minting method comprising:
generating non-fungible token information including digital content information, a token serial number, Uniform Resource Locator (URL) information, and a token ID, and storing the non-fungible token information at an address indicated by the URL information;
visualizing the URL information to display it on a tangible physical card;
registering user identification information for identifying a user through a user terminal, and creating a blockchain wallet corresponding to the user identification information;
when the blockchain wallet is created, matching and storing wallet address information of the blockchain wallet with the user identification information; and
minting the non-fungible token to the blockchain wallet by recognizing the URL information displayed on the physical card through the user terminal while the application is active and recording the token ID and the wallet address information stored at the address indicated by the URL information to the blockchain network through the application.

12. The NFT minting method of claim 11, wherein the visualizing of the URL information to display it on a tangible object comprises converting the URL information into a barcode or a QR code to display it on the physical card.

13. The NFT minting method of claim 11, wherein the minting of the non-fungible token comprises allowing a token used as a fee required to execute a transaction to mint the non-fungible token to be transferred from a blockchain wallet other than the blockchain wallet to which the non-fungible token is minted.

14. The NFT minting method of claim 11, wherein the minting of the non-fungible token comprises transferring a token used as a fee required to execute a transaction to mint the non-fungible token to the blockchain wallet to which the non-fungible token is minted prior to executing the transaction to mint the non-fungible token.

15. The NFT minting method of claim 11, further comprising checking an amount of tokens used as a fee required to execute a transaction to mint the non-fungible token held in the blockchain wallet and, when the amount of the tokens is lower than a predetermined value, transferring the token used as the fee to the blockchain wallet.

16. The NFT minting method of claim 11, further comprising matching and storing approval information for approving a transaction to mint the non-fungible token to the blockchain wallet with the user identification information.

17. The NFT minting method of claim 16, wherein the minting of the non-fungible token comprises:
recognizing the URL information displayed on the physical card through the user terminal while the application is active;
When the URL information is recognized through the user terminal, retrieving the non-fungible token information from the address indicated by the URL information;
requesting the token ID included in the retrieved non-fungible token information and the wallet address information matched with the user identification information to be transferred to a contract address of the non-fungible token; and
retrieving the approval information matched with the user identification information to approve the request.

18. The NFT minting method of claim 11, wherein the digital content information comprises one or more of image data, sound source data, and video data.

19. The NFT minting method of claim 11, wherein the URL information comprises the token serial number.

20. The NFT minting method of claim 11, wherein the user identification information comprises one or more of an e-mail address of the user and a unique name of the user input by the user.

21. A non-fungible token (NFT) minting system for minting an NFT to a blockchain network at a request of a user terminal, the NFT minting system comprising:
a content information storage configured to store digital content information including one or more of image data, sound source data, and video data;
a token information storage configured to store one or more non-fungible token information including corresponding digital content information, a token identification number, and a token ID, at an address corresponding to token identification information; and
a control server configured to, when user identification information is input through the user terminal, create a blockchain wallet corresponding to the user identification information, and match and store wallet address information of the blockchain wallet with the user identification information, and when the token identification information is input through the user terminal, mint the non-fungible token to the blockchain wallet having the wallet address information matched with the user identification information using the non-fungible token information stored at the address corresponding to the token identification information.

22. The NFT minting system of claim 21, wherein the token identification information is visualized and displayed on a tangible object.

23. The NFT minting system of claim 21, wherein the token identification information is converted into a barcode or QR code and displayed on a tangible object.

24. The NFT minting system of claim 21, wherein the control server is configured to allow a token used as a fee required to execute a transaction to mint the non-fungible token to be transferred from a blockchain wallet other than the blockchain wallet to which the non-fungible token is minted.

25. The NFT minting system of claim 21, wherein the control server is configured to transfer a token used as a fee required to execute a transaction to mint the non-fungible token to the blockchain wallet to which the non-fungible token is minted prior to executing the transaction to mint the non-fungible token.

26. The NFT minting system of claim 21, wherein the control server is configured to check an amount of tokens used as a fee required to execute a transaction to mint the non-fungible token held in the blockchain wallet and, when the amount of the tokens is lower than a predetermined value, transfer the token used as the fee to the blockchain wallet.

27. The NFT minting system of claim 21, further comprising a wallet information storage configured to store the wallet address information matched with the user identification information and approval information for approving a transaction of the blockchain wallet.

28. The NFT minting system of claim 27, wherein the control server is configured to:
control the wallet address information matched with the user identification information and the approval information to be stored in the wallet information storage; and
in the case that the token identification information is input through the user terminal when the non-fungible token is minted, retrieve the non-fungible token information from an address indicated by the token identification information, request the token ID and the wallet address information matched with the user identification information to be transferred to a contract address of the non-fungible token, and retrieve the approval information to approve the request.
